(19) United States
(12) Patent Application Publication
(10) Pub. No.: US 2026/0270130 A1
(43) Pub. Date: Sep. 10, 2026

(54) METHODS OF RECEIVING AND TRANSMITTING BINARY DATA SEQUENCES IN OTFS-BASED MULTI-USER SCMA COMMUNICATION SYSTEMS WITH COORDINATED MULTIPOINT, AND RECEIVER AND TRANSMITTER IMPLEMENTING THE METHOD

(71) Applicants: Continental Automotive Technologies GmbH, Hannover (DE); NANYANG TECHNOLOGICAL UNIVERSITY, Singapore (SG)

(72) Inventors: Yao GE, Singapore (SG); Yong Liang GUAN, Singapur (SG); David GONZÁLEZ GONZÁLEZ, Hannover (DE)

(73) Assignees: Continental Automotive Technologies GmbH, Hannover (DE); NANYANG TECHNOLOGICAL UNIVERSITY, Singapore (SG)

(21) Appl. No.: 18/993,680

(22) PCT Filed: Jul. 13, 2023
(86) PCT No.: PCT/IB2023/057174

§ 371 Date: Jan. 13, 2025

(30) Foreign Application Priority Data
Jul. 15, 2022 (DE) 10 2022 117 815.3

(51) Int. Cl. H04L 27/26; H04B 7/024; H04L 1/00; H04W 88/08

(52) U.S. Cl. CPC H04L 27/2639; H04B 7/024; H04L 1/0052; H04L 27/2605; H04W 88/085

(57) ABSTRACT

A method of receiving binary data sequences from one or more mobile UEs represented by SCMA signals transmitted to at least two RRHs, communicatively connected to a common BBU and serving the one or more mobile UEs from different directions, of a COMP radio communication system over an OTFS communication channel continuous time domain signals representing the SCMA signals transmitted from the mobile UEs are received at each RRH. After removing cyclic prefixes from the received time-domain signals an OTFS demodulation is performed on the received signals, and the resulting two-dimensional arrangements of information symbols in the delay-Doppler domain are subjected to a centralized or to a decentralized signal detection and recovery, both of which perform an iterative Gaussian approximation expectation propagation process on the information symbols. The detected symbols are de-mapped for recovering the transmitted binary sequences of the respective mobile UE whose signals had been received.

### CROSS REFERENCE TO RELATED APPLICATIONS

This application is the U.S. National Phase Application of PCT International Application No. PCT/IB2023/057174, filed Jul. 13, 2023, which claims priority to Germany Patent Application No. 10 2022 117 815.3, filed Jul. 15, 2022, the contents of such applications being incorporated by reference herein.

### FIELD OF THE INVENTION

The present invention relates to methods of transmitting and/or receiving binary data sequences in orthogonal time frequency space (OTFS)-based multi-user (MU) sparse code multiple access (SCMA) wireless communication systems with coordinated multipoint (COMP). The present invention also relates to a transmitter and a receiver implementing the method, and a system comprising one or more such transmitters and receivers, respectively.

### NOTATIONS

Throughout this specification, bold symbols represent vectors or matrices, as in x and X, respectively. Scalar values are denoted herein by lowercase letters in italics, as in x. Superscripts T and H, respectively denote the transpose and complex conjugate transpose of a vector or matrix.

### BACKGROUND OF THE INVENTION

The sixth generation (6G) wireless communications and beyond are expected to serve an ever-increasing number of high-mobility users, e.g., vehicles, subways, highways, trains, drones, low earth orbit (LEO) satellites, etc.

The preceding fourth and fifth generation (5G) wireless communications use orthogonal frequency division multiplexing (OFDM), which provides high spectral efficiency and high robustness against frequency selective fading channel, and also allow for using low-complexity equalisers. However, due to speed-dependent Doppler shifts or spreads and quickly varying multipath reception, high-mobility communications such as those required on high-speed railways and vehicle-to-everything (V2X) suffer from severe time and frequency dispersiveness. Time and frequency dispersiveness cause inter-carrier-interference (ICI) and signal fading at the receiver, and the fading is thus also referred to as doubly selective channel fading. Doubly selective channel fading significantly impairs the performance of OFDM communication.

As an alternative to OFDM, OTFS modulation was proposed as a solution for coping with doubly selective fading channels.

OTFS modulation is a 2D modulation scheme that multiplexes information QAM symbols over carrier waveforms that correspond to localized pulses in a signal representation that is referred to as delay-Doppler representation. The OTFS waveforms are spread over both time and frequency while remaining roughly orthogonal to each other under general delay-Doppler channel impairments. In theory, OTFS combines the reliability and robustness of spread spectrum with the high spectral efficiency and low complexity of narrowband transmission.

The OTFS waveforms couple with the wireless channel in a way that directly captures the underlying physics, yielding a high-resolution delay-Doppler Radar image of the constituent reflectors. As a result, the time-frequency selective channel is converted into an invariant, separable and orthogonal interaction, where all received symbols experience the same localized impairment and all the delay-Doppler diversity branches are coherently combined.

This renders OTFS ideally suited for wireless communication between transmitters and receivers that move at high speeds with respect to each other, e.g., receivers or transmitters located in high-speed trains, cars and even aircrafts.

FIG. 1 shows a block diagram of an exemplary OTFS transmission system. A transmitter 300 comprises a first transmitter-side transformation unit 306 and a second transmitter-side transformation unit 308, which form an OTFS modulator 310 (not indicated in this figure). Serial binary data is input to a signal mapper (not shown in the figure) that outputs a two-dimensional sequence of information symbols x[k, l] in which the QAM symbols are arranged along the delay period and the Doppler period of the delay-Doppler domain. The information symbols comprise data symbols and pilot symbols. Depending on the type of pilot symbols, guard symbols may surround the pilot symbols. The two-dimensional sequence of information symbols x[k, l] is input to the first transmitter-side transformation unit 306 and is subjected to an inverse Finite Symplectic Fourier Transformation (iSFFT), which produces a matrix X[n, m] that represents the two-dimensional sequence of information symbols x[k, l] in the time-frequency domain. As the transmitter transmits in the time domain, a further transformation in the second transmitter-side transformation unit 308 is required, which produces the signal s[t] in the time domain, e.g., a Heisenberg transformation. The signal s[t] is then transmitted via an antenna 316 over the communication channel.

In a realistic environment the transmitted signal, on its way from the transmitter through the communication channel to the receiver, is subject to doubly selective fading with Doppler spread. The received signal is a superposition of a direct copy and a plurality of reflected copies of the transmitted signal, where each copy is delayed by a path delay that is dependent from the length of the signal's path delay and is frequency shifted by the Doppler shift that depends from the differential speed between transmitter, reflector, and receiver. Each of the signal copies is weighted in accordance with its particular path delay and differential speed. Typical Doppler shifts are on the order of 10 Hz-1 kHz, though larger values may occur in scenarios with extremely high mobility (e.g., high-speed trains) and/or high carrier frequency. As in realistic environments it is very likely that multiple reflectors and/or moving reflectors are present, the received superimposed signal is spread out over a frequency range rather than merely shifted in frequency, and the signal deformation is thus also referred to as Doppler spread. In the following description the realistic communication channel is also referred to as practical communication channel.

In FIG. 1 the practical communication channel is represented by the undisturbed radio waves emitted from the transmitter antenna 306 and the various unordered radio waves coming from different directions and with different distances to each other at the receiver antenna 402. The radio waves may arrive at the receiver's antenna directly or after being reflected one or several times at one or more stationary and/or moving objects, which may introduce Doppler shift and different delays to the reflected radio waves.

The receiver 400 picks up the received signal r[t] in the time domain, which is provided to a first receiver-side transformation unit 408, in which it is subjected to a Wigner transform for transforming the received signal r[t] into a matrix Y[n, m] representing the received signal r[t] in the time-frequency domain. For enabling signal detection in the delay-Doppler domain the matrix Y[n, m] is then provided to a second receiver-side transformation unit 410, where it is subjected to a Finite Symplectic Fourier Transformation (SFFT), which outputs a two-dimensional sequence of information symbols y[k, l] in the delay-Doppler domain. The first and the second receiver-side transformation units form an OTFS demodulator 412. The two-dimensional sequence of information symbols y[k, l] is input to a channel estimation and equalisation block 414, which performs channel estimation CE and signal detection SD and reconstructs the symbols that were originally transmitted, and ultimately to a de-mapper that outputs the binary data that was originally transmitted (de-mapper not shown in the figure).

In vehicular communications, where a large number of users moving fast yet at different speeds and in different directions require radio access and communication, an overload situation in traditional access schemes like time division multiple access (TDMA) etc. can quickly occur. Such scenario may also be referred to as massive multiple access.

Non-orthogonal multiple access (NOMA) has been considered as a promising solution for high spectrum efficiency in traditional overloaded multi-user OFDM and multiple-input multiple-output (MIMO) systems. Existing NOMA methods are mainly categorized into power-domain and code-domain NOMA. The application of NOMA to OTFS can effectively improve spectrum utilization and support massive mobile connectivity, as has been shown by A. Chatterjee, V. Rangamgari, S. Tiwari, and S. S. Das, in “Nonorthogonal multiple access with orthogonal time-frequency space signal transmission,” IEEE Syst. J., vol. 15, no. 1, pp. 383-394, March 2021, and Z. Ding, R. Schober, P. Fan, and H. V. Poor, in “OTFS-NOMA: An efficient approach for exploiting heterogenous user mobility profiles,” IEEE Trans. Commun., vol. 67, no. 11, pp. 7950-7965, November 2019. In OTFS-NOMA, the multiple mobile users are allowed to share the same delay-Doppler resources simultaneously, and are distinguished by either different power levels or through coding, e.g., sparse codewords.

In particular, sparse code multiple access (SCMA), which is a code-domain NOMA, may provide excellent performance and low receiver complexity, as discussed by K. Deka, A. Thomas, and S. Sharma, in “OTFS-SCMA: A code-domain NOMA approach for orthogonal time frequency space modulation,” IEEE Trans. Commun., vol. 69, no. 8, pp. 5043-5058, August 2021.

An SCMA encoder maps log₂(M) bits to a K-dimensional codeword of size M selected from a predefined codebook. K dimensions are corresponding to K different orthogonal tones, such as OFDMA subcarriers. The K-dimensional codeword is a vector with only N<K nonzero entries. Users cannot transmit data through the subcarriers represented by the other N−K zero entries. Theoretically, each user can be allocated to more than one codebook, and each codebook can be utilized by more than one user generally. However, in the present specification it is assumed that each user employs only one SCMA layer.

FIG. 2 shows an example of SCMA encoding, with 6 layered codebooks CB1 . . . CB6 (variable nodes) and 4 subcarriers SC1 . . . SC4 (function nodes). Each row denotes a dimension, and each column represents a 4-dimensional codeword. In each codebook, the constellation size is 4, which means there are 4 different codewords that can be chosen. The white entries denote the zero elements and the patterned entries denote the non-zero elements in the codebooks. For example, in Codebook 1, the entries in the first row are patterned and the entries in the third row are white, which means the first dimension is non-zero and third dimension is zero. In each codebook, there are 2 non-zero dimensions with patterned lattice. In an AWGN channel, the signal received in the base station is the superposition of the codewords selected from the codebooks, indicated by the combined pattern in each subcarrier.

Codebook design is the most important part in an SCMA encoder. The target is to design a multi-dimensional lattice constellation with dimensional dependency and power variation of the constellation while maintaining large minimum Euclidean distance.

Generally, there are 3 stages to design SCMA code:

1) The Mapping Matrix stage determines the number of layers interfering at each subcarrier, which represents the complexity of the detection. The example shown in FIG. 2 can be considered a mapping matrix, which means that each layer will be interfered by two other layers.

2) The Constellation Points and Multi-dimensional Mother Constellation design stage, in which first a base constellation with a maximized minimum Euclidean distance is designed. Second, a unitary rotation, which might be designed to maximize the minimum product distance of the constellation, can be applied on the base constellation to control the dimensional dependency and power variation. Third, the complex constellation is built based on the rotated base constellation by shuffling. Last, the rotation is utilized to minimize the projection points.

3) The Constellation Function Operator stage, which includes several operators like complex conjugate, phase rotation and dimensional permutation, aims to design distinct codebooks for the collision layers.

Existing NOMA implementations provide poor performance when it comes to managing radio access for groups of radio-connected mobile user equipment (UE) as they pass along multiple remote radio heads (RRH) connected to a base band unit (BBU) of a public radio network (PRN).

FIG. 3 illustrates an exemplary traditional cellular network providing communication for a plurality of mobile UEs. Multiple RRHs are connected to a common BBU via a bi-directional connection, which can be wired or wireless. Each RRH exclusively serves all UEs that are within its radio range, indicated by the largely ovoid shape emerging from the respective RRH's antenna, irrespective of their position relative to the RRH and whether they approach the RRH or move away therefrom. Whenever a UE leaves the radio range of one RRH, a handover algorithm is executed in the BBU or a controller further out in the system, and the UE will be served by another RRH. Uplink connections are shown in solid lines, while downlink connections are shown in dashed lines.

Attempts have been made to improve the service to the mobile UEs by separating a radio coverage area into sectors, with individual RRHs from sets of co-located RRHs serving mobile UEs within their respective assigned sectors. FIG. 4 depicts such a known communication system, in which multiple sets of co-located RRHs are connected to a common BBU via bi-directional connections, which can be wired or wireless. A respective RRH from a set of co-located RRHs provides communication to mobile UEs within its assigned sector. An intra-set handover from one RRH to another within the set of co-located RRHs is performed for a mobile UE as it moves from one sector to another. The set of co-located RRHs creates a combined radio range for the set, indicated by the largely ovoid shape emerging from the respective co-located RRH's antennas. Whenever a UE leaves the radio range of one set of co-located RRHs, a handover algorithm is executed in the BBU or a controller further out in the system, and the UE will be served by another set of co-located RRHs. Uplink connections are shown in solid lines, while downlink connections are shown in dashed lines.

The known communication systems and the operation thereof not only require significant resources for the inter-RRH or inter-set handover, but also make less-than-possible use of system's resources.

### SUMMARY OF THE INVENTION

Thus, an aspect of the present invention includes proposing an improved OTFS access scheme permitting simultaneous communication of multiple UEs, where each UE is served simultaneously by RRHs located in different spatial directions relative to a position of the user.

Obviously, a moving UE that is simultaneously being served by multiple RRHs will inevitably experience positive and negative Doppler frequency shifts at the same time when the UE moves away from one RRH and approaches another one, or will experience at least different Doppler shifts as it moves relative to the RRHs.

An aspect of the present invention addresses this issue by combining an OTFS-based SCMA (OBSCMA) with coordinated multi-point (CoMP) transmission and reception, which permits exploitation of additional diversity coming from the Doppler domain and the spatial domain, while providing simultaneous communication for multiple mobile users.

Coordinated Multi-Point transmission and reception refers to a wide range of different techniques with the common denominator being the dynamic coordination of transmission and/or reception at multiple geographically separated sites with the aim to enhance system performance and end-user service quality. CoMP, which combines antennas from multiple small-cells to create additional spatial dimensions, was originally proposed to improve the average spectral efficiency and alleviate inter-cell-interference between neighbouring cells in traditional cellular networks. CoMP includes, inter alia, dynamic inter-cell scheduling coordination and joint transmission/reception at multiple sites. Joint reception means that the signals received at multiple sites are jointly processed for enhanced reception performance. Maximum-ratio combining and interference-rejection combining are examples of schemes that can be used to combine the uplink transmission received at multiple points. Joint transmission implies that data is transmitted from a mobile terminal to several sites, or in the opposite direction, to a mobile terminal jointly from several sites, thereby not only reducing the interference but also increasing the received power. The transmission to and from the sites can also take the instantaneous channel conditions at the different terminals into account to enhance the received signal strength, while at the same time reducing the interference between different transmissions.

FIG. 5 a) shows a schematic representation of the data processing and message flow in a general CoMP system in the download direction. FIG. 5 b) represents a schematic representation of the data processing and message flow in the general CoMP system in the upload direction. In FIG. 5 a), the data processing in the BBU prepares data to be sent to the UE, represented by the mobile phone icon, via all three of the RRHs, represented in the figure by the antenna masts. The processing may, inter alia, take different channel properties for the communication link from each RRH to the UE into account, such that the information sent to each RRH may slightly differ, yet carries the same payload. In FIG. 5 b) all RRHs transmit the respective received signal to the BBU for processing.

An aspect of the present invention suggests grouping multiple users for SCMA and, in order to better utilise the potential performance gain provided by distributed antenna systems an aspect of the present invention, to employ CoMP transmission and reception which, in particular in connection with distributed antenna systems, provides useful diversity and favourable propagation properties for mobile communications. While CoMP was originally proposed to improve average spectral efficiency and alleviate intercell interference between in traditional cellular networks, an aspect of the present invention adopts the CoMP operation between neighbouring RRHs for improved exploitation of the diversity.

In the following section the uplink in a CoMP system is discussed, in which system a BBU is connected with multiple RRHs via a bi-directional connection, which can be wired or wireless, including electrical or optical links. The RRHs are placed along a path followed by multiple mobile UEs. An exemplary schematic representation of this setting is shown in FIG. 6.

At each transmit slot, J independent mobile UEs located in the same cell are served by a first RRH in front of them and a second RRH behind them simultaneously.

The expression ‘in front of’ relates to a direction lying at any angle within a semi-circle, extending around the UE, whose diameter or base lies perpendicular to the direction of travel of the UE or perpendicular to a straight line between the first and second RRH, and whose arc faces towards the direction of travel of the UE or the first RRH. The UE moves towards an RRH ‘in front of’ the UE.

Correspondingly, the expression ‘behind’ relates to a direction lying at any angle within a semi-circle, extending around the UE, whose diameter or base lies perpendicular to the direction of travel of the UE or perpendicular to a straight line between the first and second RRH, and whose arc faces opposite the direction of travel of the UE or towards the second RRH. The UE moves away from an RRH ‘behind’ the UE.

Obviously, the communication connection between a UE and the first RRH and the communication connection between the same UE and the second RRH will be subject to different Doppler shift. One communication connection will experience positive Doppler shift, whereas the other communication connection will experience negative Doppler shift.

While in the following the simplified scenario of one RRH lying ‘in front of’ a UE and one RRH lying ‘behind’ a UE is assumed it is obvious that a generalization into the two RRHs lying ‘in different directions with regard to the UE’ is likewise covered by an aspect of the present invention, as different Doppler shift will likewise be present in the generalized scenario.

In a first step the binary data from the UE is mapped into corresponding K-dimensional SCMA codewords. It is assumed that each UE employs only one SCMA layer and that J>K typically, resulting in an overloading factor δ=J/K>1. Further, the SCMA codewords are assigned over the delay-Doppler plane and OTFS modulation is adopted for uplink transmission.

Without loss of generality, a lattice in delay-Doppler plane is denoted as

$$Γ = \{ ( \frac{ℓ}{M Δ f} , \frac{k}{NT} ) , ℓ = 0 , … , M - 1 ; k = 0 , … , N - 1 \}$$

and the corresponding time-frequency plane is given by

$$Λ = \{ ( m Δ f , nT ) , m = 0 , … , M - 1 ; n = 0 , … , N - 1 \}$$

where M and N denote, respectively, the total available numbers of subcarriers and time intervals. The choices of T and Δf=1/T (Hz) should be larger than the maximum channel delay spread and maximum Doppler frequency shift, respectively. To avoid unnecessary confusion, a simple model is used in which each of the UEs and each of the RRHs is equipped with a single transmit antenna and receive antenna. It is worth mentioning that the proposed model also applies to the scenarios involving multiple transmit and receive antennas on the UEs and RRHs, with expected performance gain.

At the transmitter and at each transmit slot, every log₂Q information bits bⱼ from the j-th user are mapped into a complex K-dimensional sparse codeword cⱼ=[c_{j,1}, c_{j,2}, . . . , c_{j,K}]T selected from a user-specific SCMA codebook [symbol] ⱼ of size Q, where j={1, 2, . . . , J}. It is assumed that only D<K non-zero entries exist among a K-dimensional codeword cⱼ.

Now the information symbols Xⱼ∈ [symbol] ^{M×N} of the j-th user can be generated by allocating

$$\frac{MN}{K}$$

SCMA codewords cⱼ over the delay-Doppler plane F without overlapping. FIG. 7 shows a schematic representation of the possible allocations of the SCMA codewords in the delay-Doppler domain. SCMA codewords can be allocated either along the delay axis, as shown in FIG. 7 a), or along the Doppler axis, as shown in FIG. 7 b). For simplicity, here, it is assumed that M and Nare integer multiples of K, i.e., [M]_{K}=[N]_{K}=0, where [·]ₖ denotes mod-k operation.

The delay-Doppler symbols Xⱼ∈ [symbol] ^{M×N} are then converted into a lattice in the time-frequency domain X̅ⱼ∈ [symbol] ^{M×N}, e.g., through an inverse symplectic finite Fourier transform (ISFFT) for each user,

$${\overline{X}}_{j} = {F}_{M} {X}_{j} {F}_{N}^{H}$$

where F_{M}∈ [symbol] ^{M×M} and F_{N}∈ [symbol] ^{N×N} denote, respectively, the normalized M-point and N-point discrete Fourier transform (DFT) matrices.

Next, each time-frequency signal X̅ⱼ is transformed into a time domain signal sⱼ ∈ [symbol] ^{MN×l}e.g., by applying a Heisenberg transform with a transmit pulse gₜₓ(t),

$${s}_{j} [ c ] = {{\sum }_{n = 0}}^{N - 1} {{\sum }_{m = 0}}^{M - 1} {\overline{X}}_{j} [ m , n ] {g}_{tx} ( {cT}_{s} - nT ) {c}^{j 2 π m Δ f ( {cT}_{s} - nT )} , c = 0 , … , MN - 1 ,$$

where Ts=1/MΔ f is the sampling interval.

A cyclic prefix (CP) is added in front of the generated time domain signal for each user. After passing through a transmit filter, each UE's signal is sent out over a doubly-selective fading channel.

The channel between j-th user and u-th RRH is characterized as

$${g}_{uj} [ c , p ] = \sqrt{PL ( {d}_{uj} )} {h}_{uj} [ c , p ] , c = 0 , … , MN - 1 ; p = 0 , … , {P}_{uj} - 1 ,$$

where PL(dᵤⱼ) represents the distance-dependent path loss, dᵤⱼ is the distance between the j-th user and the u-th RRH, and u={1, 2}. Note that for simplicity it is assumed that the distance remains constant during an OTFS transmission frame. hᵤⱼ represents the time-varying multipath fading channel with sampled impulse response

$${h}_{uj} [ c , p ] = {\sum }_{i = 1}^{{L}_{uj}} {h}_{uj , i} {e}^{j 2 π {v}_{uj , i} ( {cT}_{s} - {pT}_{s} )} {P}_{rc} ( {pT}_{s} - {t}_{uj} - {τ}_{uj , i} ) ,$$

$$c = 0 , … , MN - 1 ; p = 0 , … , {P}_{uj} - 1 ,$$

where Lᵤⱼ and tᵤⱼ denote the number of multipaths and the amount of timing offset between the j-th user and u-th RRH; h_{uj,i}, τ_{uj,i} and v_{uj,i} are the corresponding channel gain, delay and Doppler frequency shift associated with the i-th path, respectively.

The Doppler frequency shift of the i-th path can be further written as v_{uj,i}=(k_{uj,i}+β_{uj,i})/NT, where integer k_{uj,i} and real β_{uj,i} ∈[−0.5, 0.5] denote the index and fractional part of v_{uj,i} respectively.

The maximum channel tap Pᵤⱼ is determined by the duration of the filter response and the maximum channel delay spread. In general, the implemented pulse shaping filters at the transmitter and receiver are the root-raised-cosine (RRC) filters, leading to an equivalent overall raised-cosine (RC) roll-off pulse for P_{rc}(τ) in the equation above. In addition, it is assumed that the CP is long enough to accommodate both the maximum timing offset and the maximum channel delay spread for all users. Hence, there is no inter-frame interference.

At the receiver, a superposition of the UE's signals is received. After the time domain signal has passed through a receive filter the CP is removed. The received signal from the j-th user at the u-th RRH can be expressed as

$${r}_{uj} [ c ] = {\sum }_{p = 0}^{{P}_{uj} - 1} {g}_{uj} [ c , p ] {s}_{j} [ {[ c - p ]}_{MN} ] , c = 0 , … , MN - 1 .$$

The resulting time domain signal rᵤⱼ∈ [symbol] ^{MN×1} is then transformed into the time-frequency domain by applying a Wigner transform with a receive pulse gᵣₓ(t),

$${\overline{Y}}_{{u}_{j}} [ m , n ] = {\sum }_{c = 0}^{MN - 1} {g}_{rx}^{*} ( {cT}_{s} - nT ) {r}_{uj} [ c ] {e}^{- j 2 π m Δ f ( {cT}_{s} - nT )} ,$$

$$m = 0 , … , M - 1 ; n = 0 , … , N - 1 .$$

Finally, the time-frequency signal Y̅ᵤⱼ∈ [symbol] ^{M×N} is transformed back to the delay-Doppler domain via applying a symplectic finite Fourier transform (SFFT),

$${Y}_{uj} = {F}_{M}^{H} + {\overline{Y}}_{uj} {F}_{N}$$

For analytical convenience, a rectangular pulse for gₜₓ(t) and gᵣₓ(t) is adopted in the above steps, and the baseband OTFS input-output relationship from j-th user to u-th RRH in delay-Doppler domain is expressed as

$${Y}_{uj} [ ℓ , k ] = \sqrt{PL ( {d}_{uj} )} \text{} {\sum }_{p = 0}^{{P}_{uj} - 1} {\sum }_{i = 1}^{{L}_{uj}} {{\sum }^{N - 1}}_{q = 0} {h}_{uj , i} \text{} {P}_{rc} ( \text{} {pT}_{s} - {t}_{uj} - {τ}_{uj , i} ) \text{} γ ( k , ℓ , p , q , {k}_{uj , i} , {β}_{uj , i} ) \times {X}_{j} [ {[ ℓ - p ]}_{M} , {[ k - {k}_{uj , i} + q ]}_{N} ] ,$$

$$where$$

$$γ ( k , ℓ , p , q , {k}_{uj , i} , {β}_{uj , i} ) = \{ \begin{matrix}\frac{1}{N} ξ ( ℓ , p , {k}_{uj , i} , {β}_{uj , i} ) θ ( q , {β}_{uj , i} ) , & p \leq ℓ < M , \\ \frac{1}{N} ξ ( ℓ , p , {k}_{uj , i} , {β}_{uj , i} ) θ ( q , {β}_{uj , i} ) ϕ ( k , q , {k}_{uj , i} ) , & 0 \leq ℓ < p ,\end{matrix}$$

$$ξ ( ℓ , p , {k}_{uj , i} , {β}_{uj , i} ) = {e}^{j 2 π ( \frac{ℓ - p}{M} ) ( \frac{{k}_{uj , i} + {β}_{uj , i}}{N} )} ,$$

$$θ ( q , {β}_{uj , i} ) = \frac{{e}^{- j 2 π ( - q - {β}_{uj , i} )} - 1}{{e}^{- j \frac{2 π}{N} ( - q - {β}_{uj , i} )} - 1} ,$$

$$ϕ ( k , q , {k}_{uj , i} ) = {e}^{- j 2 π \frac{{[ k - {k}_{uj , i} + q ]}_{N}}{N}} .$$

The input-output relationship developed above can be further column-wise vectorized as

$${y}_{uj} = {H}_{uj} {\tilde{x}}_{j} ,$$

where \tilde{x}ⱼ, yᵤⱼ∈ [symbol] ^{MN×1}, and HᵤⱼE∈ [symbol] ^{MN×MN} is a sparse matrix. Consequently, the observations obtained at u-th RRH can be expressed as

$${\overline{y}}_{u} = {\sum }_{j = 1}^{J} \sqrt{{P}_{j}} {H}_{uj} {\tilde{x}}_{j} + {ω}_{u} , \qquad u = 1 , 2$$

where ωᵤ∈ [symbol] ^{MN×1~}XN (0, N₀I) is the complex additive white Gaussian noise (AWGN) at u-th RRH, and Pⱼ is the transmission power of j-th user.

An exemplary schematic block diagram of the uplink system discussed hereinbefore is illustrated in FIG. 8. The figure shows J transmitters 300, some elements of one of which are shown in the dashed-line box in the figure. In each transmitter 300 a binary data sequence bⱼ is provided to a SCMA mapper 302, which outputs a corresponding codeword cⱼ, that is allocated, in an SCMA codeword allocator 304, for obtaining an information symbol Xⱼ in the delay-Doppler domain. The information symbol Xⱼ is subjected to an OTFS modulation in OTFS modulator 310, and a CP is added, in CP adder 312, to the signal sⱼ output by the OTFS modulator 310. After passing through a transmit filter 314 the signal is transmitted to the two or more RRHs 400 of the system.

The transmission is represented by the arrows going from each transmit filter 314 to each of the antenna inputs 402 of the RRHs, represented by the adder symbols. At the antenna inputs 402 of the RRHs added noise is received in addition to the signals from the transmitters 300. In each RRH 400, the received superimposed signals and noise are passed through receive filter 404 before the CPs are removed in CP removal unit 406. The resulting CP-less signal is provided to OTFS demodulator 408, which outputs the demodulated signal y̅ᵤ to a centralized or a decentralized decoder 420. After decoding the signals from the two or more RRHs the resulting decoded signal is provided to SCMA demapper 422, and the demapped signals are output.

An exemplary method of transmitting and receiving signals or symbols transmitted via OTFS is disclosed in the German patent application 10 2021 126 321.1, which is hereby incorporated in its entirety.

In the following section the recovery of signals for each UE from the signals received at the RRHs in a practical receiver is discussed. To this end the equation for the received signal y̅ᵤ at the RRH can be rewritten as

$${\overline{y}}_{u} = {\overline{H}}_{u} \overline{x} + {ω}_{u} ; u = 1 , 2$$

$$where {\overline{H}}_{u} = [ \sqrt{{P}_{1}} {H}_{u 1} , \sqrt{{P}_{2}} {H}_{u 2} , … , \sqrt{{P}_{J}} {H}_{uJ} ] ∈ {ℂ}^{MN \times MNJ} , and$$

$$\overline{x} = {[ {\tilde{x}}_{1}^{T} , {\tilde{x}}_{2}^{T} , … , {\tilde{x}}_{J}^{T} ]}^{T} ∈ {ℂ}^{MNJ \times 1} .$$

Note that x̅ is a sparse vector due to the sparse SCMA codewords. The number of non-zero entries in x̅ is only

$$\frac{M N J D}{K} . \hat{x} ∈ ℂ \frac{M N J D}{K} \times 1$$

denotes the effective input after removing the zeros in x̅, and

$${\hat{H}}_{u} ∈ {ℂ}^{M N \times \frac{M N J D}{K}}$$

represents the effective matrix after deleting the columns corresponding to the indices of zeros in x̅. The relationship for y̅ᵤ can thus be simplified to

$${\overline{y}}_{u} = {\hat{H}}_{u} \hat{x} + {ω}_{u} ; u = 1 , 2 ,$$

As \hat{x} contains information from

$$\frac{M N J}{K}$$

SCMA codewords, every D non-zero elements from the same SCMA codeword in \hat{x} are grouped. Similarly, the corresponding columns in Ĥᵤ are grouped together. The equation for the received signal y̅ᵤ at the RRH can now further be rewritten as

$${{\overline{y}}_{u} = {H}_{u} x + {ω}_{u} ; u = 1 , 2 , where \\ x = [ {x}_{1}^{T} , {x}_{2}^{T} , ⋯ , {x}_{MNJ / K}^{T} \}}^{T} ∈ {ℂ}^{\frac{MNJD}{K} \times 1} , {x}_{c} ∈ {ℂ}^{D \times 1} , {h}_{d , c}^{u} ∈ {ℂ}^{1 \times D} and \\ {H}_{u} = [ \begin{matrix}{h}_{1 , 1}^{u} & {h}_{1 , 2}^{u} & ⋯ & {h}_{1 , MNJ / K}^{u} \\ {h}_{2 , 1}^{u} & {h}_{2 , 2}^{u} & ⋯ & {h}_{2 , MNJ / K}^{u} \\ ⋮ & ⋮ & ⋱ & ⋮ \\ {h}_{MN , 1}^{u} & {h}_{MN , 2}^{u} & ⋯ & {h}_{MN , MNJ / K}^{u}\end{matrix} ] ∈ {ℂ}^{M N \times \frac{M N J D}{K}} .$$

It can easily be observed that the dimension of receptions at each RRH is less than the number of transmitted SCMA codewords, as J>K. Hence, conventional multi-user detection for orthogonal multiple access cannot be directly applied in such an over-loaded system. To achieve better performance, advanced receiver algorithms are required to recover the signals of each UE.

In the following, efficient centralized and decentralized detector for multi-user detection are presented, and their respective advantages and disadvantages are discussed.

First, a centralized detector taking advantage of signals of corresponding correlated transmission time slots received at multiple RRHs is presented. In the centralized detector the RRHs will forward the received signals to the BBU for centralized multi-user detection. Note that any time difference between the correlated signals may be compensated for or corrected in the BBU. The received signal vector can be expressed as

$$y = Hx + ω , where y = {[ {\overline{y}}_{1}^{T} , {\overline{y}}_{2}^{T} ]}^{T} ∈ {ℂ}^{2 MN \times 1} , H = {[ {H}_{1}^{T} , {H}_{2}^{T} ]}^{T} ∈ {ℂ}^{2 MN \times \frac{MNJD}{K}} , and ω = {[ {ω}_{1}^{T} , {ω}_{2}^{T} ]}^{T} ∈ {ℂ}^{2 MN \times 1} .$$

A direct solution of the foregoing equation is computationally complex as it involves a large matrix inverse, while MN typically is in the order of thousands or even larger in OTFS communication systems. A sparsely connected factor graph can advantageously be used for describing the linear model, since H is a sparse matrix. The corresponding factor graph includes 2MN observation nodes y_{d}, d=1, 2, . . . , 2MN, and

$$\frac{M N J}{K}$$

variable nodes

$${x}_{c} , c = 1 , 2 , … , \frac{MNJ}{K} .$$

An edge is connected between an observation node y_{d} and a variable node x_{c} if h_{d,c}≠0_{1×D}. Let I (d) and [symbol] (c) denote the index sets of non-zero components (i.e., h_{d,c}≠0_{1×D}) in the d-th row and c-th column of H, where d=1, 2, . . . , 2MN and

$$c = 1 , 2 , … , \frac{MNJ}{K} ,$$

respectively. The corresponding numbers of non-zero components in the d-th row and c-th column are represented as |I(d)| and | [symbol] (c)|.

Several general low complexity, efficient message passing (MP) algorithms for symbol detection in sparse factor graphs are known. However, the known methods of detection may not show the performance required in the OTFS-based multi-user SCMA CoMP communication system discussed herein.

In the following section a customized symbol detector implementing Gaussian approximation with expectation propagation (GAEP) is proposed. The customized GAEP detector further improves the performance of the previously known expectation propagation (EP) concept for symbol detection, which already brought a performance improvement over known MP detector concepts while having a modest complexity. Notably, the proposed GAEP detector overcomes the co-channel user interference and the self-interference in the delay-Doppler domain. Co-channel user interference refers to interference caused by signals of UEs transmitting on the same channel in multi-user settings. Self-interference, or multi-path self-interference, refers to the interference caused by the multi-path transmissions of the same UE.

The system model discussed further above and ultimately developed into the equation

$$[ \begin{matrix}{\overline{y}}_{1} \\ {\overline{y}}_{2}\end{matrix} ] = [ \begin{matrix}{H}_{1} \\ {H}_{2}\end{matrix} ] x + [ \begin{matrix}{ω}_{1} \\ {ω}_{2}\end{matrix} ]$$

at a BBU with two RRHs can be represented by a factor graph, in which each factor node y_{d} is connected to multiple variable nodes x_{c}, with d=1, 2, . . . , 2MN and

$$c = 1 , 2 , … , \frac{M N J}{K} .$$

An exemplary factor graph is shown in FIG. 9. An iterative processing loop is executed between the factor nodes y_{d}, represented as square boxes, and the respective variable nodes x_{c}, represented as circles, until a termination criterion is met. The iteration count is indicated by κ Inputs to the iteration process are the OTFS-decoded information symbols y̅ᵤ from the respective RRH, corresponding information Hᵤ on the properties respective channels between the UE and the two RRHs, the a priori probability PD(x) and the maximum number of iterations n_{c}.

After initializing the mean

$${μ}_{d , c}^{( 0 )}$$

and variance

$${η}_{d , c}^{( 0 )} , with c = 1 , 2 , … , \frac{M N J}{K}$$

and d∈ [symbol] (c), and after setting the convergence indicator δ₁ to zero and setting the iteration count κ to 1, the iterative process is started. In the process, the iteration comprises calculations of the transmitted messages on the factor nodes, whose results are passed to the connected variable nodes. Corresponding calculations of the transmitted messages are carried out in the variable nodes, whose results are passed back to the factor nodes. The passing of results of calculations is iteratively repeated until a termination criterion is met.

At each observation node the received signal y_{d} can be expressed as

$${𝓎}_{d} = {\sum }_{i = 1 , {h}_{d , c} [ i ] \neq 0}^{D} {h}_{d , c} [ i ] {x}_{c} [ i ] + {\sum }_{e ∈ ℐ ( d ) , e \neq c} {h}_{d , e} {x}_{e} + {ω}_{d} .$$

The updated messages from each iteration in the observation node yᵤ are passed to the connected variable nodes x_{c}, c∈I(d). The updated and passed messages are approximated as Gaussian. Hence, the observation node y_{d} sends the mean

$${C}_{d , c}^{( κ )} [ i ]$$

and variance

$${D}_{d , c}^{( κ )} [ i ]$$

to the variable node x_{c} if h_{d,c}[i]≠0, i=1, 2, . . . , D, where

$${C}_{d , c}^{( κ )} [ i ] = \frac{1}{{h}_{d , c} [ i ]} [ {y}_{d} - {\sum }_{\text{?}} {\text{?}}_{\text{?}} {μ}_{d , c}^{( κ - 1 )} = {\sum }_{\text{?}}^{D} {h}_{d , c} [ f ] {μ}_{d , c}^{( κ - 1 )} [ f ] ] , \qquad ( 1 )$$

$${D}_{d , c}^{( κ )} [ i ] = \frac{1}{{\vert {h}_{d , c} [ i ] \vert}^{2}} [ {\sum }_{\text{?}} {\sum }_{f = 1}^{D} {\vert {h}_{d , c} [ f ] \vert}^{2} {η}_{d , c}^{( κ - 1 )} [ f ] + {\sum }_{\text{?}}^{D} {\vert {h}_{d , c} [ f ] \vert}^{2} {η}_{d , c}^{( κ - 1 )} [ f ] + {σ}^{2} ] . \qquad ( 2 )$$

$$\text{?} \text{indicates text missing or illegible when filed}$$

Here,

$${μ}_{d , e}^{( κ - 1 )} and {η}_{d , e}^{( κ - 1 )}$$

are the mean and variance vectors received from variable node xₑ in the (κ−1)-th iteration. They can be initialized in the first iteration by projecting the equiprobable symbols into a Gaussian distribution as shown further below. σ² is the variance of the noise at the receiver input.

At each variable node x_{c} the a posteriori probability is determined based on the information received from the connected factor nodes. The a posteriori probability can be expressed as follows at each variable node

$${\overline{P}}^{( κ )} ( {x}_{c} = {χ}_{j} ) ∝ {P}_{D} ( {x}_{c} = {χ}_{j} ) {\prod }_{\text{?}} {\prod }_{\text{?}} exp ( - \frac{{\vert {χ}_{j} [ i ] - {C}_{\text{?}}^{\text{?}} [ i ] \vert}^{2}}{{D}_{\text{?}}^{\text{?}} [ i ]} ) , ∀ {χ}_{j} ∈ {\overline{𝔸}}_{j} , \qquad ( 3 )$$

$$where j = ⌈ \frac{c K}{M N} ⌉$$

$$\text{?} \text{indicates text missing or illegible when filed}$$

┌·┐ denotes the round up operation. [symbol] ⱼ is a set containing the nonzero elements of the predefined j-th user SCMA codebook [symbol] ⱼ and χⱼ is a D-dimensional codeword from [symbol] ⱼ. P_{D} (x_{c}=χⱼ) represents the a priori probability when x_{c}=χⱼ, which can be assumed with equiprobable symbols if no priori information is observed. The current a posteriori probability is then projected into a Gaussian distribution

$$X N ( {E}_{c}^{( κ )} [ i ] , {F}_{c}^{( κ )} [ i ] ) , i = 1 , 2 , … , D$$

and set a minimum allowed variance ε, i.e.,

$${F}_{c}^{( κ )} [ i ] = max \{ ε , {F}_{c}^{( κ )} [ i ] \}$$

to avoid numerical instabilities. The mean

$${E}_{c}^{( κ )} [ i ]$$

and variance,

$${F}_{c}^{( κ )} [ i ]$$

of the projection are given by

$${E}_{c}^{( κ )} [ i ] = {\sum }_{{χ}_{j} ∈ {\overline{𝔸}}_{j}} {\overline{P}}^{( κ )} ( {x}_{c} = {χ}_{j} ) {χ}_{j} [ i ] , \qquad ( 4 )$$

$${F}_{c}^{( κ )} [ i ] = {\sum }_{{χ}_{j} ∈ {\overline{𝔸}}_{j}} {\overline{P}}^{( κ )} ( {x}_{c} = {χ}_{j} ) {\vert {χ}_{j} [ i ] \vert}^{2} - {\vert {E}_{c}^{( κ )} [ i ] \vert}^{2} . \qquad ( 5 )$$

Following a Gaussian message combining rule, as discussed, e.g., by I. Santos, J. J. Murillo-Fuentes, E. Arias-de Reyna, and P. M. Olmos, in “Turbo EP-based equalization: A filter-type implementation,” IEEE Trans. Commun., vol. 66, no. 9, pp. 4259-4270, September 2018 and by S. [symbol] ahin, A. M. Cipriano, C. Poulliat, and M.-L. Boucheret, “Iterative [symbol] equalization with decision feedback based on expectation propagation,” IEEE Trans. Commun., vol. 66, no. 10, pp. 4473-4487, October 2018, the extrinsic distribution

$${\overline{q}}_{E}^{( κ )} ( {x}_{d , c} [ i ] ) ∼ XN ( {\overline{μ}}_{d , c}^{( κ )} [ i ] , {\overline{η}}_{d , c}^{( κ )} [ i ] )$$

can be updated if h_{d,c}[i]≠0, 1=1, 2, . . . , D, where

$${\overline{η}}_{d , c}^{( κ )} [ i ] = {[ {( {F}_{c}^{( κ )} [ i ] )}^{- 1} - {( {D}_{d , c}^{( {r}_{u} )} [ i ] )}^{- 1} ]}^{- 1} , \qquad ( 6 )$$

$${\overline{μ}}_{d , c}^{( κ )} [ i ] = {\overline{η}}_{d , c}^{( κ )} [ i ] [ \frac{{E}_{c}^{( κ )} A [ i ]}{{F}_{c}^{( κ )} [ i ]} - \frac{{C}_{d , c}^{( κ )} [ i ]}{{D}_{d , c}^{( κ )} [ i ]} ] . \qquad ( 7 )$$

Finally, the variable node x_{c} calculates the mean

$${μ}_{d , c}^{( κ )} [ i ]$$

and variance

$${η}_{d , c}^{( κ )} [ i ]$$

as follows and passes them back to the factor node y_{d}, d∈ [symbol] (c),

$${η}_{d , c}^{( κ )} [ i ] = {[ \frac{Δ}{{\overline{η}}_{d , c}^{( κ )} [ i ]} + \frac{( 1 - Δ )}{{η}_{d , c}^{( κ )} [ i ]} ]}^{- 1} , \qquad ( 8 )$$

$${μ}_{d , c}^{( κ )} [ i ] = {η}_{d , c}^{( κ )} [ i ] [ Δ \frac{{\overline{μ}}_{d , c}^{( κ )} [ i ]}{{\overline{η}}_{d , c}^{( κ )} [ i ]} + ( 1 - Δ ) \frac{{μ}_{d , c}^{( κ )} [ i ]}{{η}_{d , c}^{( κ )} [ i ]} ] ,$$

Where Δ∈(0,1] is a message damping factor adopted to improve the performance and convergence. If the renewed variance

$${η}_{d , c}^{( κ )} [ i ]$$

is negative, the current update is ignored and the value of the previous iteration is utilized instead.

In the exemplary process discussed herein a convergence indicator

$${δ}_{I}^{( κ )}$$

is defined as

$${δ}_{I}^{( κ )} = \frac{K}{MNJ} {\sum }_{c = 1}^{MNJ / K} 𝕀 ( {max}_{{χ}_{j} ∈ {\overline{𝔸}}_{j}} {\overline{P}}^{( κ )} ( {x}_{c} = {χ}_{j} ) \geq 1 - ϱ ) , j = ⌈ \frac{cK}{MN} ⌉$$

for some small [symbol] >0 and [symbol] (·) stands for the indicator function. The convergence indicator is used for determining whether or not the results from the previous iteration are updated. Here, the convergence indicator determines that P(x_{c}) is updated as

$$P ( {x}_{c} ) = {\overline{P}}^{( κ )} ( {x}_{c} ) , c = 1 , 2 , … , \frac{MNJ}{K} .$$

$$if {δ}_{I}^{( κ )} > {δ}_{I}^{( κ - 1 )} .$$

After each iteration loop a termination criterion is checked. The centralized GAEP detector discussed herein terminates if

$${δ}_{I}^{( κ )} = 1$$

or the maximum iteration number n_{c} is reached. Once the termination criterion is satisfied \hat{δ}_{c} can be determined as

$${\hat{x}}_{c} = arg max P ( {x}_{c} = {χ}_{j} ) , j = ⌈ \frac{cK}{MN} ⌉ , c = 1 , 2 , … , \frac{MNJ}{K} .$$

$${χ}_{j} ∈ \overline{{𝔸}_{J}}$$

Finally, the SCMA de-mapping is applied to recover the transmitted information bits of each user.

It is noted that while the system description provided prior to the discussion of the iterative process refers to a system with two RRHs an extension to any other number of RRHs or antennas can be easily made in the same gist.

An exemplary schematic block diagram of the proposed GAEP detector process is shown in FIG. 10. At the factor node operations including, e.g., an expectation propagation estimation with Gaussian approximation, are carried out. The operations at the factor node use the information available at the RRHs 400, including intermediate results of calculations of each of variable nodes as they become available in each iteration. The results of the operations at the factor node are provided to the connected variable nodes. At each variable node operations including, e.g., determining an a posteriori probability and message combining, are carried out using information pertaining to a respective UE 300, including intermediate results of calculations of the factor node as they become available in each iteration. The results of the operations at the variable nodes are provided to the factor node after damping, which improves the convergence of the process. In accordance with an aspect of the invention the messages updated and passed between the factor node and variable nodes on the factor graph are approximated as Gaussian, which reduces the computational complexity over the use of exact messages.

The centralized GAEP detecting process for two RRHs as carried out between the factor nodes and the variable nodes can be briefly summarized as

Input: y̅₁, y̅₂, H₁, H₂, PD(x) and n_{c}.
$Initialization : {μ}_{d , c}^{( 0 )} , {η}_{d , c}^{( 0 )} , c = 1 , 2 , … , \frac{MNJ}{K} , d ∈ \text{?} ( c ) , {δ}_{I}^{( 0 )} = 0$
and iteration count κ = 1.
Iteratively repeat
$a ) calculate , in each factor node {y}_{d} , the mean {C}_{d , c}^{( κ )} [ i ] and variance {D}_{d , c}^{( κ )} [ i ] , and$
send them to the connected variable nodes x_{c}, c ∈ I(d), if h_{d,c}[i] ≠ 0,
i = 1, 2, ... , D;
$b ) generate , in each variable node {x}_{c} , the mean {μ}_{d , c}^{( κ )} [ i ] and variance {η}_{d , c}^{( κ )} [ i ] , and$
pass them back to the connected observation nodes yₐ, d ∈ [symbol] (c) if h_{d,c}[i] ≠ 0, i = 1,
2, ... , D;
$c ) Compute the convergence indicator ( {δ}_{I}^{( κ )} ) ;$
$d ) Update P ( x ) = {\overline{P}}^{( κ )} ( x ) if {δ}_{I}^{( κ )} > {δ}_{I}^{( κ - 1 )}$
e) κ := κ + 1;
$until {δ}_{I}^{( κ )} = 1 or κ = {n}_{c}$
Output: P(x).

Next, a decentralized detector taking advantage of direct connections between RRHs grouped to serve a defined area is presented. The connection may be wired or wireless, including electrical or optical connections in the wired case. Direct connections between the RRHs allow for implementing decentralized processing in a straightforward manner to enable the cooperation between these RRHs, which requires frequent communications between the RRHs.

The process structure of the decentralized detector is shown in FIG. 11. Here, a first and a second RRH are grouped to serve a defined area. Specifically, the two RRHs apply a GAEP detecting process similar to that presented above, albeit independently, for symbol detection, and exchange information iteratively to further improve the performance.

After obtaining the extrinsic mean

$${\overline{E}}_{c}^{2} [ i ]$$

and variance

$${\overline{F}}_{c}^{2} [ i ] , i = 1 , 2 , … , D ,$$

$$c = 1 , 2 , … , \frac{MNJ}{K}$$

from the second RRH, the a priori probability is updated at the first RRH as

$${P}_{D} ( {x}_{c} = {χ}_{j} ) ∝ {\prod }_{i = 1}^{D} exp ( - \frac{{\vert {χ}_{j} [ i ] - {\overline{E}}_{c}^{2} [ i ] \vert}^{2}}{{\overline{F}}_{c}^{2} [ i ]} ) , \\ ∀ {χ}_{j} ∈ {\overline{𝔸}}_{j} , j = ⌈ \frac{cK}{MN} ⌉ , c = 1 , 2 , … , \frac{MNJ}{K} .$$

By applying the GAEP process presented above for a certain number n_{I} of iterations, the first RRH projects the output probabilities

$$P ( {x}_{c}^{1} )$$

into the a posteriori Gaussian distribution

$$XN ( {E}_{c}^{1} [ i ] , {F}_{c}^{1} [ i ] ) , i = 1 , 2 , … , D , c = 1 , 2 , … , \frac{MNJ}{K}$$

in a similar way as in the centralized detector previously discussed.

The extrinsic mean

$${\overline{E}}_{c}^{1} [ i ]$$

and variance

$${\overline{F}}_{c}^{1} [ i ]$$

can be calculated as follows and then delivered to the second RRH,

$${\overline{F}}_{c}^{1} [ i ] = {[ {( {F}_{c}^{1} [ i ] )}^{1} - {( {\overline{F}}_{c}^{2} [ i ] )}^{- 1} ]}^{- 1} ,$$

$${\overline{E}}_{c}^{1} [ i ] = {\overline{F}}_{c}^{1} [ i ] [ \frac{{E}_{c}^{1} [ i ]}{{F}_{c}^{1} [ i ]} - \frac{{\overline{E}}_{c}^{2} [ i ]}{{\overline{F}}_{c}^{2} [ i ]} ] .$$

Similarly, the second RRH first updates the a priori probability P_{D}(x_{c}) and then produces the a posteriori Gaussian distribution for each symbol by using the GAEP process with n_{I} iterations. The extrinsic mean

$${\overline{E}}_{c}^{2} [ i ]$$

and variance

$${\overline{F}}_{c}^{2} [ i ] ,$$

$$i = 1 , 2 , … , D , c = 1 , 2 , … , \frac{MNJ}{K}$$

are finally generated and passed back to the first RRH to form the iterative loop. After a certain number nₒ of iterations, each RRH obtains a final decision of \hat{x} in the last iteration step.

The decentralized detecting process with each of the RRHs carrying out a GAEP detection can be briefly summarized as

Input: y̅₁, y̅₂, H₁, H₂, n_{I} and nₒ.
Initialization: Ē^{u} and F̅^{u}, u = {1; 2}.
Iteratively repeat nₒ times and in parallel at each RRH (i.e., u = 1, 2)
a) Update P_{D} (x);
b) Obtain the output probabilities P(x^{u}) by employing the GAEP process with n_{I}
iterations;
$c ) Project P ( {x}_{c}^{u} ) into the Gaussian distribution XN ( {E}_{c}^{u} [ i ] , {F}_{c}^{u} [ i ] ) ,$
$i = 1 , 2 , … , D ; c = 1 , 2 , … , \frac{MNJ}{K} ) ;$
$d ) Compute the extrinsic mean {\overline{E}}_{c}^{u} [ i ] and variance {\overline{F}}_{c}^{u} [ i ] , i = 1 , 2 , … , D ,$
$c = 1 , 2 , … , \frac{MNJ}{k} ;$
Exchange the extrinsic mean Ē^{u} and variance F̅^{u} between the two RRHs.
Repeat until nₒ iterations are done, then output: P(x^{u}), u = {1, 2}.

As can be seen from the discussion above, the complexity of the proposed centralized and decentralized detectors are mainly determined by the steps of the GAEP. For each main loop iteration of the GAEP, equations (1)-(9) have a complexity order O(S̅D), O(S̅D), O(S̅DQ),

$$O ( \frac{2 MNJDQ}{K} ) ,$$

O(2SD) and O(2S̅D), respectively. For conciseness, S̅ represents

$${\sum }_{d = 1}^{2 MN} \vert I ( d ) \vert = {\sum }_{c = 1}^{MNJ / K} \vert ϑ ( c ) \vert .$$

Therefore, the overall complexity orders are

$${n}_{c} O ( 6 \overline{S} D + \overline{S} D Q + \frac{2 MNJDQ}{K} ) and {n}_{o} {n}_{I} O ( 6 \overline{S} D + \overline{S} D Q + \frac{4 MNJDQ}{K} )$$

for the centralized and the decentralized detectors, respectively.

In light of the foregoing discussion and in accordance with a first aspect of the invention a method of receiving binary data sequences from one or more mobile UEs is presented, which binary data sequences are represented by SCMA signals transmitted to at least two RRHs of a CoMP radio communication system over an OTFS communication channel subject to doubly selective fading, in which system the at least two RRHs are communicatively connected to a common BBU and serve the one or more mobile UEs from different directions relative to the respective mobile UE. The method comprises receiving, at each of the at least two RRHs, continuous time domain signals representing the SCMA signals transmitted from the one or more mobile UEs. In a following step, in each of the at least two RRHs, cyclic prefixes are removed from the received time-domain signal, and in each of the at least two RRHs an OTFS demodulation is performed on the received continuous time-domain signals, yielding corresponding two-dimensional arrangements of information symbols y̅ᵤ in the delay-Doppler domain. The respective two-dimensional arrangements of information symbols y̅ᵤ in the delay-Doppler domain from the at least two RRHs and information Hᵤ on the properties of the respective channels between the one or more mobile UEs and the at least two RRHs are than provided or subjected to a centralized or to a decentralized signal detection. In accordance with an aspect of the present invention both the centralized and the decentralised signal detection perform a GAEP process in the information symbols y̅ᵤ. The detected symbols can then be de-mapped for recovering the transmitted binary sequences of the respective mobile UE whose signals had been received.

Simulations show that similar values of n_{c} and nₒn_{I} are required to guarantee the convergence of the methods. Hence, the proposed centralized and decentralized detectors have comparable computational complexity, and are both efficient for recovering the signal of each individual user.

However, the centralized detector may suffer from high communication overhead for information transfer between the RRHs and the BBU, especially when each RRH has a large number of antennas. The amount of complex-valued data passed from each RRH to the BBU contains MNNᵤ receptions and 3NᵤLᵤ channel state information (CSI), where Nᵤ represents the number of antennas at u-th RRH and

$${L}_{u} = {\sum }_{j = 1}^{J} {L}_{uj} , ∀ u = \{ 1 , 2 \} .$$

The BBU then broadcasts

$$\frac{MNJD}{K}$$

detected complex-valued data to each RRH afterwards. Therefore, the overall complex-valued data passed between the RRHs and the BBU in centralized detector is

$$MN ( {N}_{1} + {N}_{2} ) + 3 ( {N}_{1} {L}_{1} + {N}_{2} {L}_{2} ) + \frac{2 MNJD}{K} .$$

For the decentralized detector, the RRHs execute local computing processing parallelly, and coordinate with each other with limited consensus information exchange. The exchanged information only includes

$$\frac{MNJD}{K}$$

and means

$$\frac{MNJD}{K}$$

variances in each iteration, resulting in

$$\frac{2 MNJD}{K} {n}_{o}$$

complex-valued data transferred among the RRHs overall. Such a small amount of data exchange can not only alleviate the excessive requirement on interconnection bandwidth among the decentralized RRHs, but also avoid the large data transfer between the RRHs and the BBU in the centralized detector.

In addition, the BBU is generally located far away from the RRHs, and requires a high computing capacity to solve the large dimension problem of multi-user detection. Therefore, the centralized detector may exhibit higher latency in the communications and thus have unwanted effects on user experience. Nevertheless, the computations can be carried out in a decentralized and parallel fashion between the two neighbouring RRHs in the decentralized detector, which significantly reduces the latency in the communication system.

Table 1 shows a comparison of properties of the centralized and decentralized detectors:

| detector | computational complexity | communication overhead | latency |
|---|---|---|---|
| centralized | ${n}_{c} O ( 6 \overline{S} D + \overline{S} DQ + \frac{2 MNJ DQ}{K} )$ | $MN ( {N}_{1} + {N}_{2} ) + 3 ( {N}_{1} {L}_{1} + {N}_{2} {L}_{2} ) + \frac{2 MNJD}{K}$ | high |
| decentralized | ${n}_{o} {n}_{I} O ( 6 \overline{S} D + \overline{S} DQ + \frac{4 MNJDQ}{K} )$ | $\frac{2 MNJD}{K} {n}_{o}$ | low |

In the following section the OBSCMA with CoMP system discussed for an uplink scenario above is extended to downlink scenarios, i.e., from the two or more RRHs to the one or more mobile UEs. An exemplary block diagram is shown in FIG. 12. Each one of the various binary data streams b_{J} to be transmitted to the respective UE is mapped, in an SCMA mapper 302 of the BBU, into SCMA signals cⱼ, and individual transmit signals Xⱼ are obtained by SCMA codeword allocation executed in an SCMA codeword allocator of the BBU. A superimposed input delay-Doppler signal X is given by

$$X = {\sum }_{j = 1}^{J} {X}_{j} ,$$

where Xⱼ∈ [symbol] ^{M×N} contains the delay-Doppler symbols of the j-th user. The BBU provides the superimposed signal X to each RRH 400, only one of which is exemplarily encircled in the box labelled ‘400’, where an OTFS modulation is applied on the superimposed signal X in OTFS modulator 310 and the CP is added in front of the generated time domain signal in CP adder 312. After passing through the transmit filter 314, each RRH 400 broadcasts the resulting time domain signal to the mobile users.

At each mobile UE 300, the transmitted signals from all RRHs 400 are received, along with the inevitable noise, at an antenna 402, represented by the adder symbol. In the respective mobile UE 300 the CP is removed, in CP removal unit 406, after the signal is output from receive filter 404. Next, the OTFS demodulation is applied, in OTFS demodulator 412, to recover the signal in the delay-Doppler domain, where the input-output relationship can be expressed as

$$\begin{matrix}{y}_{j} = {\sum }_{u = 1}^{2} \sqrt{{P}_{u}} {H}_{uj} \tilde{x} + {ω}_{j} \\ = ( \sqrt{{P}_{1}} {H}_{1 j} + \sqrt{{P}_{2}} {H}_{2 j} ) \tilde{x} + {ω}_{j} \\ = {\tilde{H}}_{j} \tilde{x} + {ω}_{j} ,\end{matrix}$$

where yⱼ ∈ [symbol] ^{MN×1} is the observed signal at the j-th user, \tilde{x}∈ [symbol] ^{MN×1} is the vectorized variant of X, ωⱼ∈ [symbol] ^{MN×1} is the complex AWGN at the j-th user, and Pᵤ represents the transmission power of the u-th RRH.

The foregoing expression can be rewritten as

$${y}_{j} = {\overline{H}}_{j} \overline{x} + {ω}_{j} \\ where \\ {\overline{H}}_{j} = [ {\tilde{H}}_{j} , {\tilde{H}}_{j} , … , {\tilde{H}}_{j} ] ∈ {ℂ}^{MN \times MNJ} , and \overline{x} = {[ {\tilde{x}}_{1}^{T} , {\tilde{x}}_{2}^{T} , … , {\tilde{x}}_{J}^{T} ]}^{T} ∈ {ℂ}^{MNJ \times 1} .$$

After removing the redundant zeros and grouping every D non-zero elements of the same SCMA codeword in x̅, the foregoing relationship can be simplified to where

$${y}_{j} = {H}_{j} x + {ω}_{j} \\ x ∈ {ℂ}^{\frac{MNJD}{K} \times 1} and {H}_{j} ∈ {ℂ}^{MN \times \frac{MNJD}{K}} .$$

Since the input-output relationship has similar properties to that of the uplink system in the case of the centralized detector previously discussed, the very same process can be used for detecting and recovering the signal from the j-th user, in detector 420, and the decoded signals are available at an output of SCMA demapper 422. It is noted that the roles of the RRH and the UE are inverted with regard to FIG. 8. Thus, some of the elements of the UE are referenced with reference numerals that were used for the RRH in FIG. 8, and vice versa.

In accordance with a second aspect of the invention a method of receiving binary data sequences represented by SCMA transmitted, over an OTFS communication channel subject to doubly selective fading, from two or more RRHs of a CoMP radio communication system to one or more mobile UEs, in which system the at least two RRHs are communicatively connected to a common BBU and serve the one or more mobile UEs from different directions, is presented. The method comprises, at each of the one or more UEs, receiving the signals from the at least two RRHs at an antenna of the UE in the time domain. After removing cyclic prefixes from the received time-domain signal, an OTFS demodulation is performed on the received continuous time-domain signal, yielding corresponding two-dimensional arrangements of information symbols y̅ᵤ in the delay-Doppler domain. The information symbols in the delay-Doppler domain from the at least two RRHs and information Hᵤ on the properties of the respective channels between the UE and the at least two first RRHs are subjected to a signal detection and recovery, whose output is de-mapped for recovering the transmitted binary sequences targeted to the mobile UE. In accordance with an aspect of the invention the signal detection and recovery comprises initializing and executing an iteration loop, the iteration loop performing, on the signals from the at least two RRHs serving the mobile UE from different directions, an iterative expectation propagation with Gaussian approximation process. The process is repeated until a termination criterion is met, upon which the detected signal is output to the de-mapping step.

In accordance with a third aspect of the invention a method of transmitting, from a common BBU and coincidingly within corresponding transmission slots via at least two RRHs connected to the common BBU in a CoMP radio system, binary data sequences destined to two or more UEs over an OTFS communication channel subject to doubly selective fading is presented. In the system the at least two RRHs are communicatively connected to a common BBU and serve the two or more mobile UEs from different directions. The method comprises, at the BBU, receiving binary sequences for the two or more UEs. Each binary data sequence to be transmitted to a corresponding UE is mapped, in a signal mapper of the BBU, into a K-dimensional SCMA codeword, the K-dimensional SCMA codeword being arranged over the delay-Doppler plane. The SCMA codewords are combined, at the BBU, codewords into a common, or shared, transmission frame, which is transmitted from the BBU to the at least two RRHs. Each RRH subjects the common/shared transmission frame to an OTFS modulation, adds a cyclic prefix (CP) to the generated time domain signal, and transmits resulting continuous time-domain signal over the communication channel to the two or more UEs.

In the following section the performance of the proposed method for both uplink and downlink communications will be evaluated using simulations. In the simulations, the carrier frequency is centered at 4 GHz and subcarrier spacing Δf=15 kHz. The roll-off factor of the RRC filters is set to 0.4 for both the transmitter and receiver. Unless otherwise specified, a delay-Doppler plane with M=64 and N=16 is considered. It is also assumed that J=6 users are sharing K=4 orthogonal resources simultaneously, and that D=2 non-zero entries are found in each codeword. The user-specific codebooks are designed as proposed by K. Xiao, B. Xia, Z. Chen, B. Xiao, D. Chen, and S. Ma, in “On capacity-based codebook design and advanced decoding for sparse code multiple access systems,” IEEE Trans. Wireless Commun., vol. 17, no. 6, pp. 3834-3849, June 2018, with size Q=4, and the transmission power is assumed to be the same.

In the simulations a scenario as shown in FIG. 6 is considered, where the mobile users are uniformly and independently distributed in the cell. The RRHs are positioned along a highway, spaced from each other by dₕ=1000 m. The perpendicular distance of the RRHs and the highway line dₚ=150 m, and the width distance of the highway road d_{w}=50 m. The distance-dependent path loss propagation is modeled as PL(d)[dB]=142.1+37.6 log₁₀(d), as proposed by M. Tao, E. Chen, H. Zhou, and W. Yu, in “Content-centric sparse multicast beamforming for cache-enabled cloud RAN,” IEEE Trans.

Wireless Commun., vol. 15, no. 9, pp. 6118-6131, September 2016, where d is the distance in kilometers. The noise power spectral density is set to be −174 dBm/Hz for each receiver. A typical urban channel model with exponential power delay profile is adopted, as discussed by M. Failli, in “Digital Land Mobile Radio Communications”, COST 207, European Communities, Luxembourg, 1989. The velocity of the j-th mobile user is set to λj=300 km/h, leading to a maximum Doppler frequency shift v_{j,max}=111 Hz, ∀j={1, 2, . . . , J}. The Doppler frequency shift for the i-th delay of the channel between the j-th user and u-th RRH is generated using the Jakes formulation as discussed by P. Raviteja, K. T. Phan, and Y. Hong, in “Embedded pilot-aided channel estimation for OTFS in delay-Doppler channels,” IEEE Trans. Veh. Tech., vol. 68, no. 5, pp. 4906-4917, May 2019 and by P. Raviteja, K. T. Phan, Y. Hong, and E. Viterbo, in “Interference cancellation and iterative detection for orthogonal time frequency space modulation,” IEEE Trans. Wireless Commun., vol. 17, no. 10, pp. 6501-6515, October 2018, i.e., v_{uj,i}=v_{j,max} cos (ρ_{uj,i}), where ρ_{uj,i} is uniformly distributed over

$$[ \frac{π}{2} , π ]$$

if the j-th user is moving away from the u-th RRH, and distributed over

$$[ 0 , \frac{π}{2} ]$$

if the j-th user is moving towards the u-th RRH.

It is assumed that the full CSIs are known at the receiver. After extensive experimentations Δ=0.3, ε=10⁻⁸, [symbol] =0.1 and n_{c}=20 are selected, for yielding an attractive compromise between convergence speed and accuracy. The simulation results are averaged over 1000 independent Monte Carlo trails.

First, the effects of SCMA codewords allocation on the receiver performance are investigated. FIG. 13 illustrates the average bit error rate (ABER) performance of the proposed OBSCMA with CoMP uplink system for different SCMA codeword allocations. Without loss of generality, a centralized GAEP detector is applied and the SCMA codewords are allocated either along the delay axis, as illustrated in FIG. 7 (a), also referred to as delay allocation, or along the Doppler axis, as illustrated in FIG. 7 (b), also referred to as Doppler allocation.

To highlight the superiority of the proposed GAEP algorithm, the baseline performance of a traditional MP algorithm as presented by H. B. Mishra, P. Singh, A. K. Prasad, and R. Budhiraja, in “OTFS channel estimation and data detection designs with superimposed pilots,” IEEE Trans. Wireless Commun., 2021, and by P. Raviteja, K. T. Phan, Y. Hong, and E. Viterbo, in “Interference cancellation and iterative detection for orthogonal time frequency space modulation,” IEEE Trans. Wireless Commun., vol. 17, no. 10, pp. 6501-6515, October 2018, is also provided in FIG. 13. It can be observed that the proposed GAEP algorithm outperforms the MP algorithm in the considered OBSCMA with CoMP uplink system. It is also noticed that the SCMA codeword allocation has a small effect on the receiver performance. In the remained of the simulations, the SCMA codewords are allocated along the delay axis unless otherwise noted.

FIG. 14 compares the ABER performance of the proposed scheme with those of the co-located RRHs scheme shown in FIG. 4 and the traditional cellular network scheme shown in FIG. 3, denoted as scheme I and scheme II, respectively. Also shown in FIG. 14 is the performance of traditional OFDM-SCMA counterparts as benchmarks for different schemes. Note that the proposed GAEP algorithm can be generalized to the OFDM-SCMA scenarios in a straightforward manner, thus, details are omitted here for the sake of brevity. The results reveal that all the receivers benefit from higher transmission power, and that the proposed OBSCMA can achieve better performance than its OFDM-SCMA counterparts for each respective scheme. The proposed OBSCMA with CoMP system significantly outperforms all other schemes due to the utilization of channel diversity.

It is also noted that, as the transmission power increases, the ABER performance of scheme I and scheme II intersect with each other for each of the OBSCMA and OFDM-SCMA scenarios. This is due to the fact that scheme II experiences favorable propagation gain but limits to the spatial diversity gain.

FIG. 15 shows the ABER performance of the proposed centralized and decentralized detectors for OBSCMA with CoMP in the system uplink. The results clearly show that the ABER performance of decentralized detector with sufficient number of iterations would asymptotically approach that of centralized detector. To guarantee the convergence of decentralized detector, a larger iteration number n_{I} requires a relatively smaller value of nₒ, and vice versa, i.e., a smaller number n_{I} demands a larger value of nₒ. Therefore, the proposed decentralized detector can yield a trade-off between the local processing efficiency of each RRH and the communication overhead between the RRHs.

In FIG. 16, the ABER performance of both the centralized and decentralized detectors for different user mobile velocities is tested. As the velocities of the mobile users grow, the ABER performance improves gradually and saturates after velocity beyond 600 km/h. This is attributed to the reason that OTFS modulation can resolve more distinct paths in the Doppler domain with the help of higher user velocity. As a result, better performance becomes possible. It is again noticed that the ABER performance of the decentralized detector approaches that of the centralized one when the iteration numbers are sufficient, and slightly degrades when the iteration numbers are inadequate for different velocities.

FIG. 17 further illustrates the ABER performance for both the centralized and decentralized detectors with n_{I}=3 and nₒ=5 under different system settings ofMand N. It is apparent that the ABER performance of both centralized and decentralized detectors improves as M and N increase, due to the higher resolution of OTFS delay-Doppler grid. This leads to diversity benefit, as the receiver can resolve a larger number of signal paths in the channel.

Finally, the ABER performance of the proposed OBSCMA with CoMP system is tested for downlink scenarios in FIG. 18. To highlight the predominance of the proposed schemes, the performance of traditional OFDM-SCMA counterparts are provided as benchmarks. The performance of a special scenario, although impractical, where the transmitted signals by the RRHs in front of and behind the users are assumed to experience both positive or negative Doppler frequency shifts, is also represented in FIG. 18, to illustrate the benefits of the proposed schemes. It is obvious that the proposed OBSCMA with CoMP system outperforms its OFDM-SCMA counterparts significantly for downlink transmissions. Comparing only the special scenarios, the proposed OBSCMA with CoMP system can exploit more diversity from the signals that experience both positive and negative Doppler frequency shifts, leading to a better performance.

The various elements of the transmitter and receiver presented herein may be implemented in hardware, as software modules, or combinations thereof, i.e., hardware that is controlled and/or parameterized through software.

The methods of receiving and transmitting, respectively, presented herein may be represented by computer program instructions which, when executed by a microprocessor, cause the computer and/or control hardware components of a receiver or a transmitter of an OTFS-based multi-user SCMA communication system with CoMP as presented hereinbefore, respectively, to execute the methods as presented hereinbefore.

The computer program instructions may be retrievably stored or transmitted on a computer-readable medium or data carrier. The medium or the data carrier may by physically embodied, e.g., in the form of a hard disk, solid state disk, flash memory device or the like. However, the medium or the data carrier may also comprise a modulated electro-magnetic, electrical, or optical signal that is received by the computer by means of a corresponding receiver, and that is transferred to and stored in a memory of the computer.

The proposed OBSCMA communication within a CoMP framework can naturally harvest diversity from the delay domain, the Doppler domain and the spatial domain for better performance, and efficiently supports massive mobile connectivity, in particular in massive mobile connectivity. The OBSCMA with CoMP system further allows for an effective processing in the receiver.

The GAEP-based detection and recovery processes for centralized and decentralized detectors proposed herein for the uplink scenario exploit the underlying channel diversity from the receptions of the RRHs connected to the same BBU. The centralized GAEP process can be used without major modifications in the downlink scenario, where superimposed signals from two or more RRHs are received by each UE. The proposed OBSCMA communication within a CoMP framework and the proposed detectors show superior effectiveness for both uplink and downlink communications, improving massive mobile connectivity, and providing high speed and ultra-reliable communications for a wide range of emerging mobile applications, including online gaming, high-speed railway systems, and vehicle-to-everything (V2X) networks.

In some of the embodiments of the systems the decoding exploits beneficial properties of mobile edge computing, inter alia, reduced communication delays and reduced risk of congestion in communication interfaces.

While an aspect of the invention has been described hereinbefore assuming that each RRH has one antenna, using multiple antenna systems can provide additional diversity, multiplexing and antenna gains compared to conventional single antenna systems, and aspects of the invention may easily be extended to such multiple antenna systems without leaving the scope of the invention.

### BRIEF DESCRIPTION OF THE DRAWING

In the following section exemplary embodiments of the invention will be described in greater detail with reference to the drawing. In the drawing,

FIG. 1 shows a block diagram of a general OTFS transmission system,

FIG. 2 shows a schematic example of SMA encoding,

FIG. 3 illustrates an exemplary traditional cellular network providing communication for a plurality of mobile UEs,

FIG. 4 depicts a known communication system, in which multiple sets of co-located RRHs are connected to a common BBU via bi-directional connections,

FIG. 5 shows a schematic representation of the message flow and data processing in a general CoMP system for the upload and download directions,

FIG. 6 shows an exemplary and schematic CoMP system exploited by an aspect of the present invention,

FIG. 7 depicts a schematic representation of the possible allocations of the SCMA codewords in the delay-Doppler domain,

FIG. 8 shows an exemplary schematic block diagram of the uplink system discussed herein,

FIG. 9 shows an exemplary factor graph of the centralized detector process,

FIG. 10 shows an exemplary block diagram of the proposed centralized GAEP detector process,

FIG. 11 shows a schematic process structure of a decentralized detector process

FIG. 12 shows an exemplary block diagram of the downlink system discussed herein,

FIG. 13 illustrates the average bit error rate (ABER) performance of the proposed OBSCMA with CoMP uplink system for different SCMA codeword allocations,

FIG. 14 shows a comparison between the ABER performances of the proposed scheme with those of the co-located RRHs scheme shown in FIG. 4 and the traditional cellular network scheme shown in FIG. 3,

FIG. 15 shows the ABER performance of the proposed centralized and decentralized detectors for OBSCMA with CoMP in the system uplink,

FIG. 16 shows the ABER performance of both the centralized and decentralized detectors for different user mobile velocities,

FIG. 17 illustrates the ABER performance for both the centralized and decentralized detectors with n_{I}=3 and nₒ=5 under different system settings of M and N,

FIG. 18 depicts a comparison of the ABER performance of the proposed method with a traditional OFDM-SCMA communication in two scenarios,

FIG. 19 shows a schematic flow diagram of a method in accordance with the first aspect of the invention,

FIG. 20 shows exemplary flow diagrams of the centralized signal detection and the decentralized signal detection, respectively,

FIG. 21 shows an exemplary flow diagram of a method in accordance with the second aspect of the invention,

FIG. 22 shows an exemplary flow diagram of a method in accordance with the third aspect of the invention,

FIG. 23 shows an exemplary block diagram of a UE in accordance with an aspect of the invention,

FIG. 24 shows an exemplary block diagram of an RRH in accordance with an aspect of the invention, and

FIG. 25 shows an exemplary block diagram of a BBU in accordance with an aspect of the invention.

Throughout the figures identical or similar elements may be referenced using the same reference designators.

### DESCRIPTION OF EXEMPLARY EMBODIMENTS

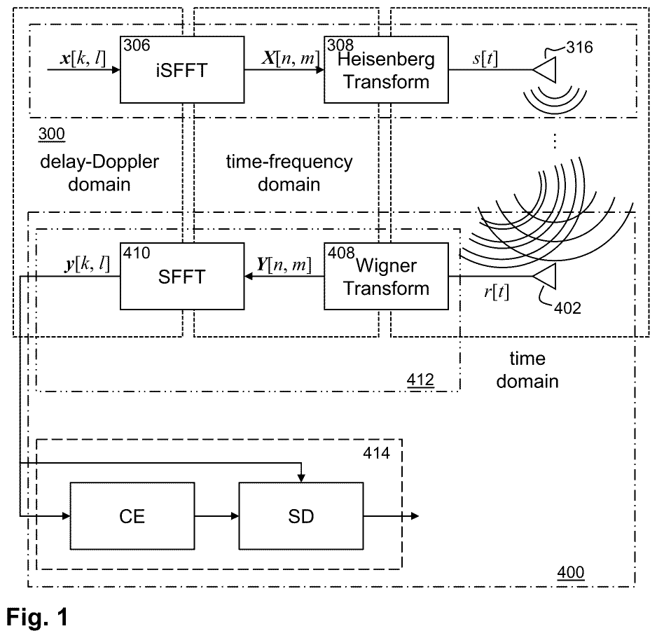

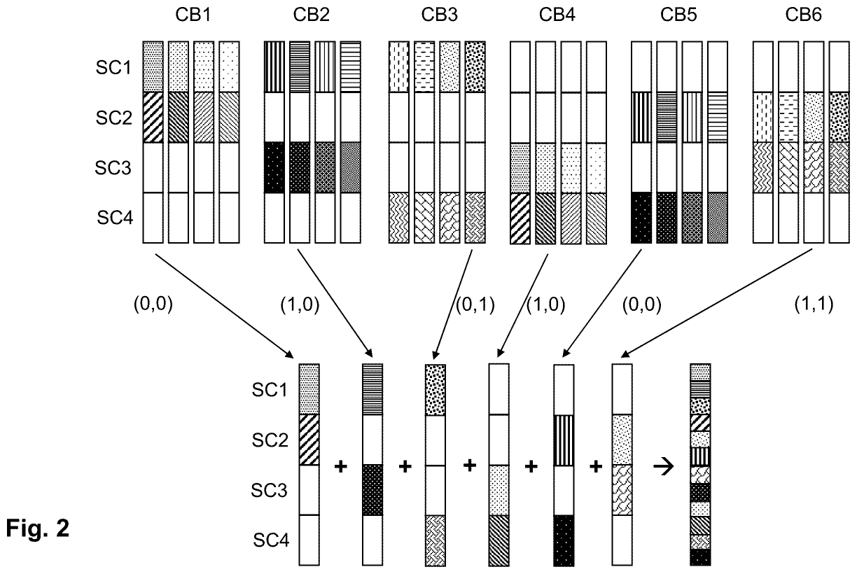

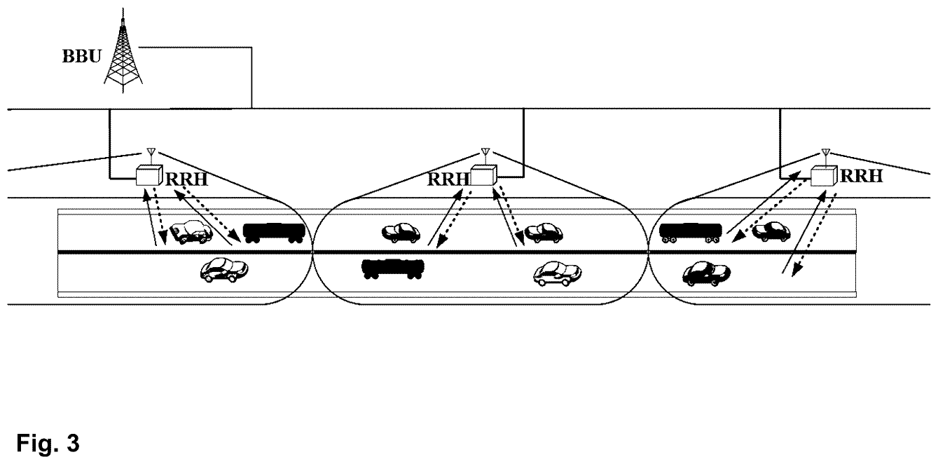

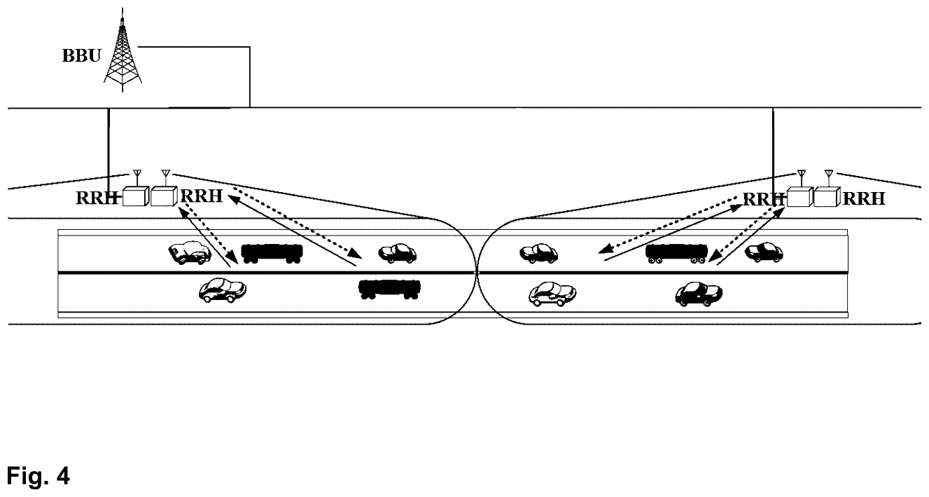

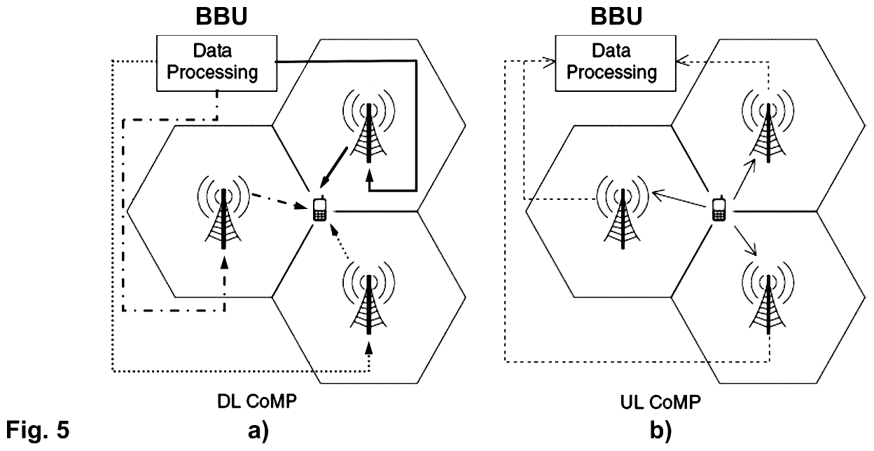

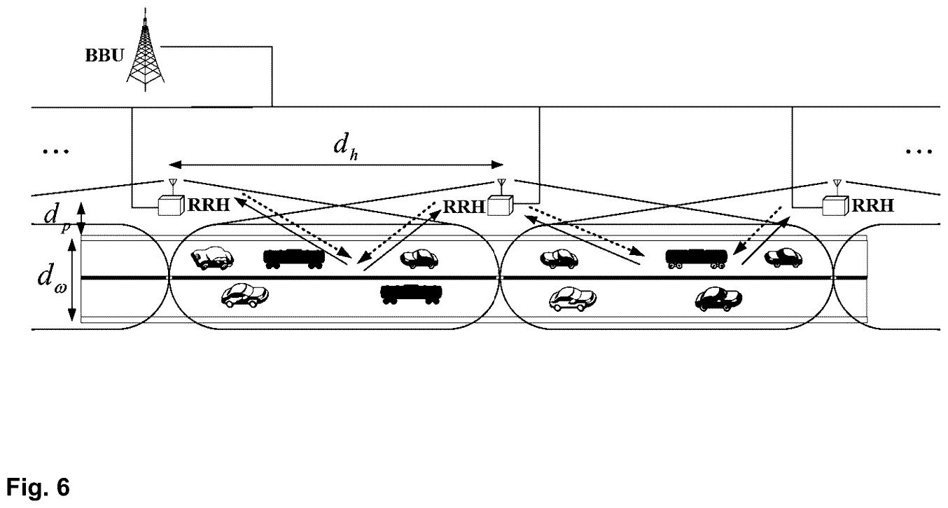

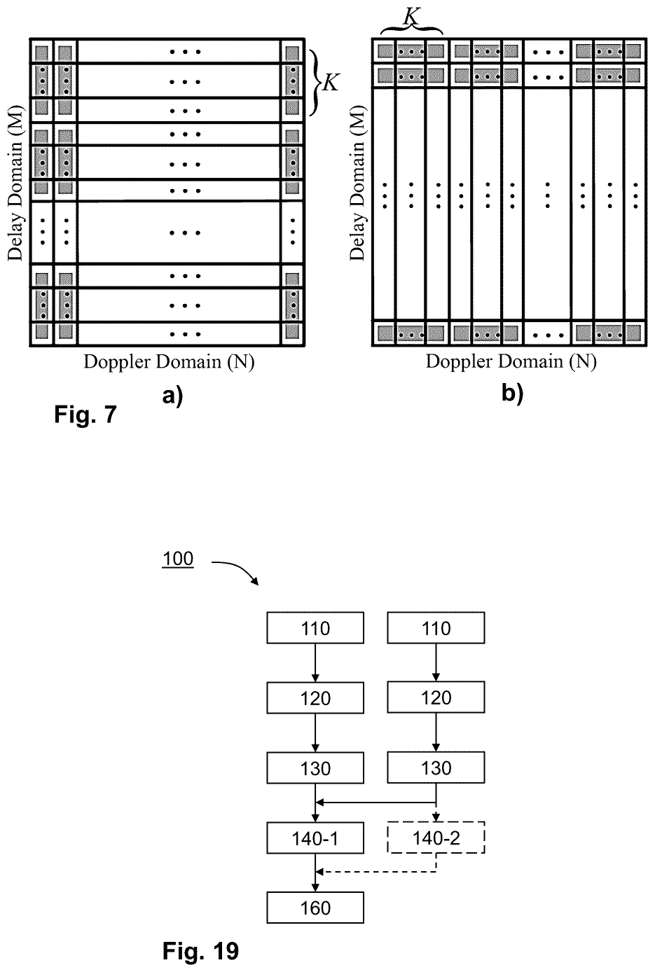

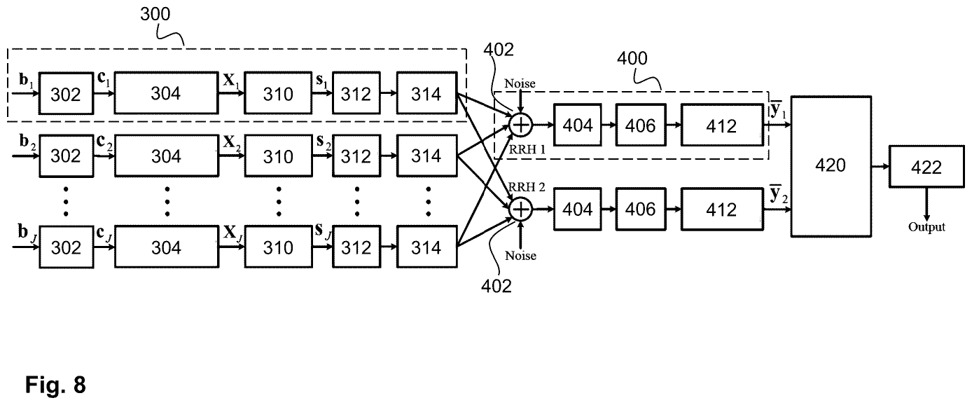

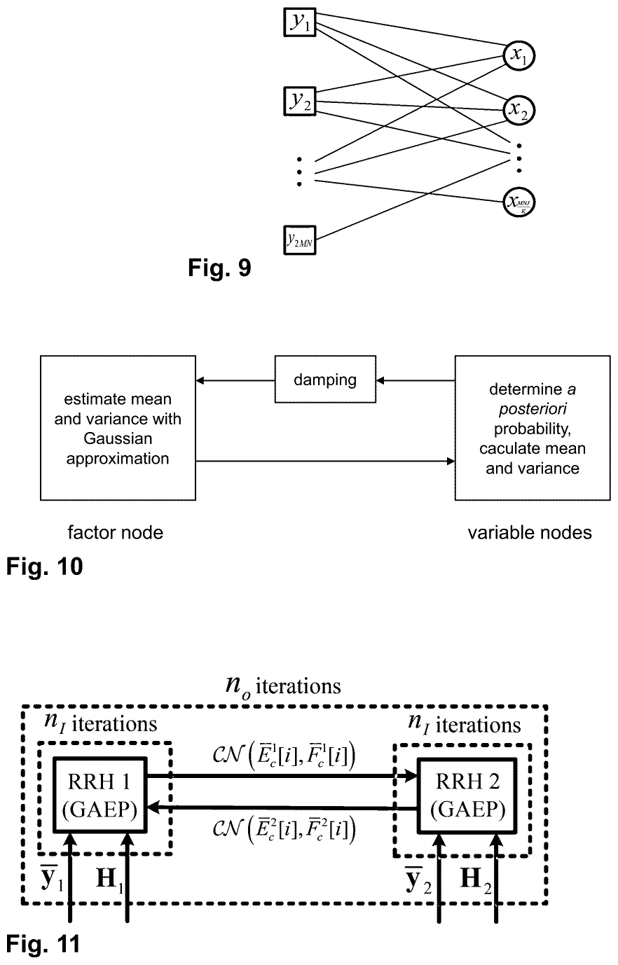

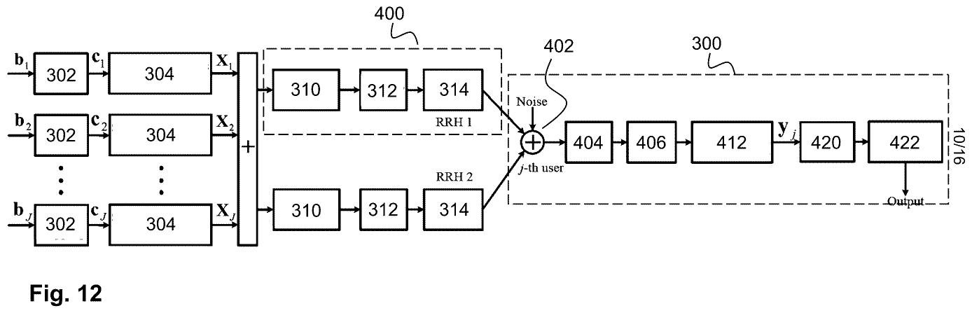

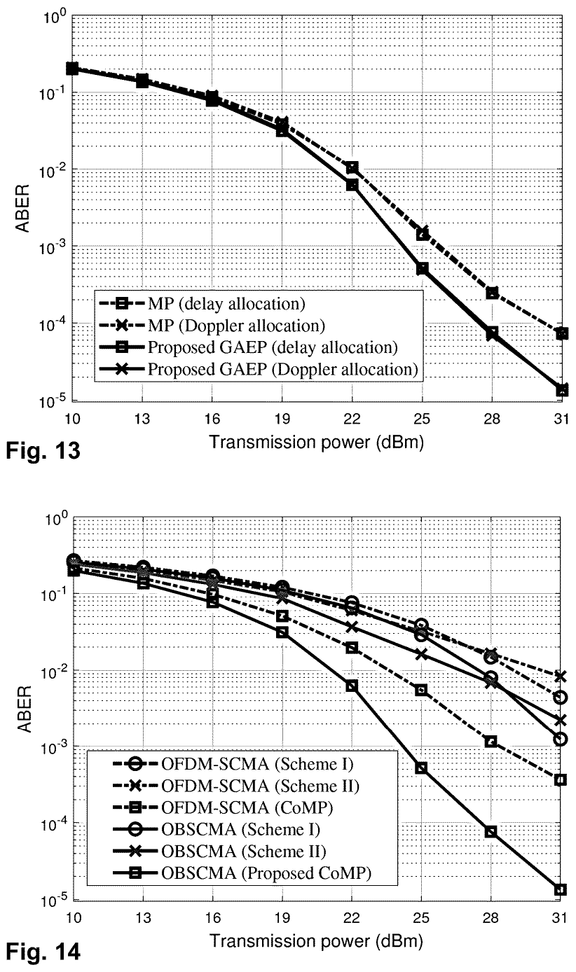

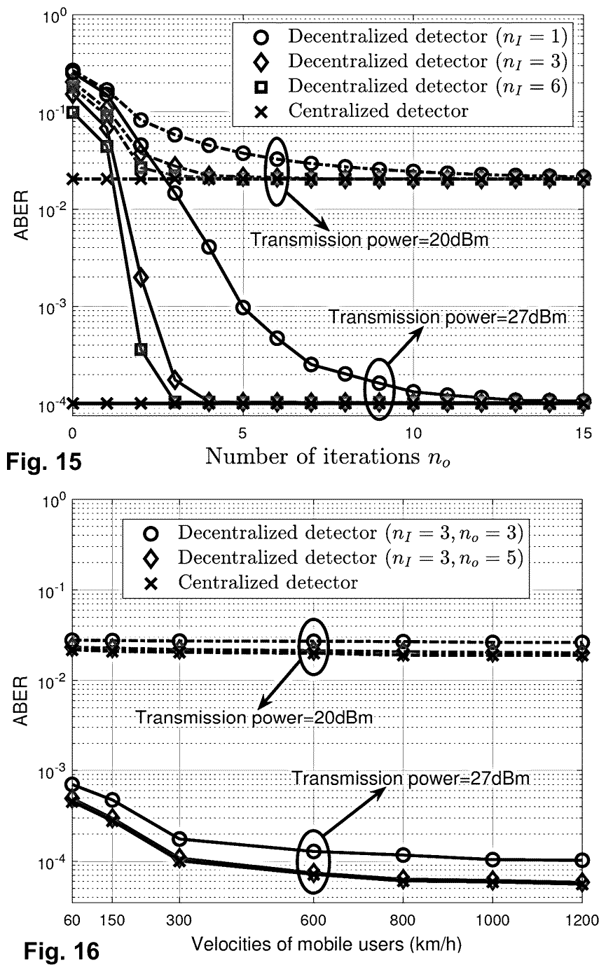

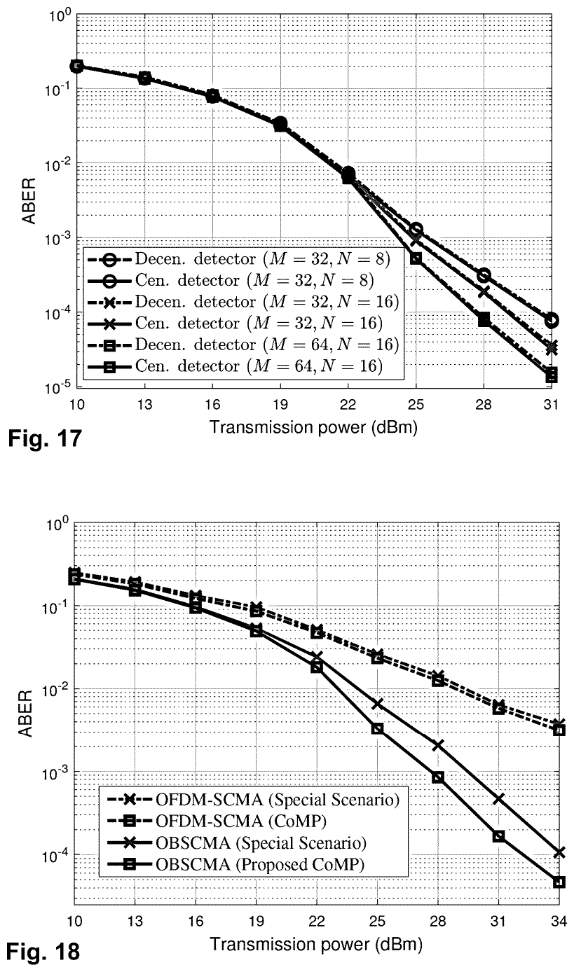

FIGS. 1 to 18 have been described further above and will not be discussed again.

FIG. 19 shows an exemplary flow diagram of a method 100 of receiving binary data sequences from one or more mobile UEs 300, in accordance with the first aspect of the invention. In step 110 continuous time domain signals representing the SCMA signals transmitted from the one or more mobile UEs 300 are received at each of the two or more RRHs 400. Next, in step 120, cyclic prefixes are removed from the received time-domain signal in each of the at least two RRHs 400, and each of the two or more RRHs performs, in step 130, an OTFS demodulation on the received continuous time-domain signals, yielding corresponding two-dimensional arrangements of information symbols in the delay-Doppler domain. In step 140 each of the two or more RRHs provides or subjects the respective two-dimensional arrangements of information symbols in the delay-Doppler domain to a centralized or decentralized signal detection. The detected signals output from the signal detection are provided to a de-mapping stage, step 160, for recovering the transmitted binary sequences of the respective mobile UE 300 whose signals had been received.

Note that in the figure the optional parallel execution of the steps for the decentralized signal detection is indicated by the box with a dashed outline and the dashed arrows connecting the boxes.

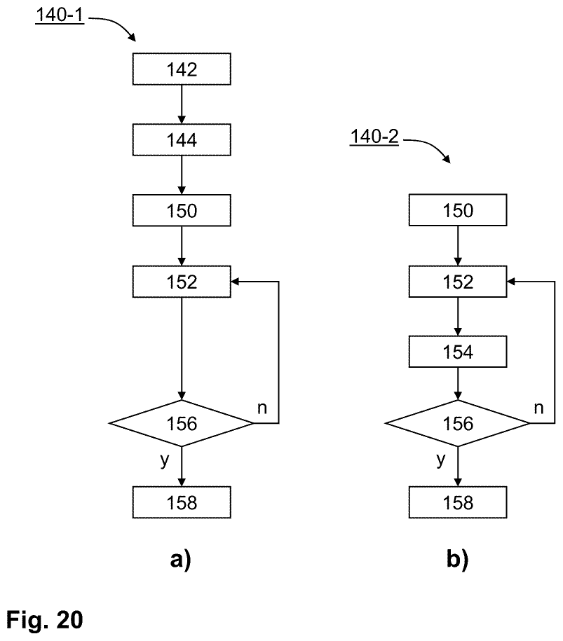

FIG. 20 a) and b) shows exemplary flow diagrams of the centralized signal detection and the decentralized signal detection, respectively. The centralized signal detection, shown in FIG. 20 a), starts with receiving, step 142, the respective two-dimensional arrangements of information symbols in the delay-Doppler domain from the at least two RRHs 400 and information on the properties of the respective channels between the UE and the at least two first RRHs 400 in the common BBU. Next, in step 144, the information from the at least two RRHs 400 is mapped on a factor graph having factor nodes and variable nodes, and in step 150 an iteration loop is initialized and executed. The iteration comprises performing, step 152, on the signals from the at least two RRHs 400 serving the one or more mobile UEs 300 from different directions, an iterative expectation propagation with Gaussian approximation process. In step 156 a check is performed if a termination criterion is met. If not, “no”-branch of step 156, the iteration is repeated. Otherwise, “yes”-branch of step 156, the detected signal is output, in step 158, to a de-mapping step (not shown in the figure).

The decentralized signal detection, shown in FIG. 20 b), starts with initializing and executing an iteration loop in step 150. The iteration comprises performing, step 152, in each of the at least two RRHs 400 serving the one or more mobile UEs 300 from different directions, an iterative expectation propagation with Gaussian approximation process on the signals received in the respective RRH 400. At the end of each iteration, in step 154, the RRHs 400 exchange the respective intermediate results, and in step 156 a check is performed if a termination criterion is met. If not, “no”-branch of step 156, the iteration is repeated. Otherwise, “yes”-branch of step 156, the detected signal is output, in step 158, to a de-mapping step (not shown in the figure).

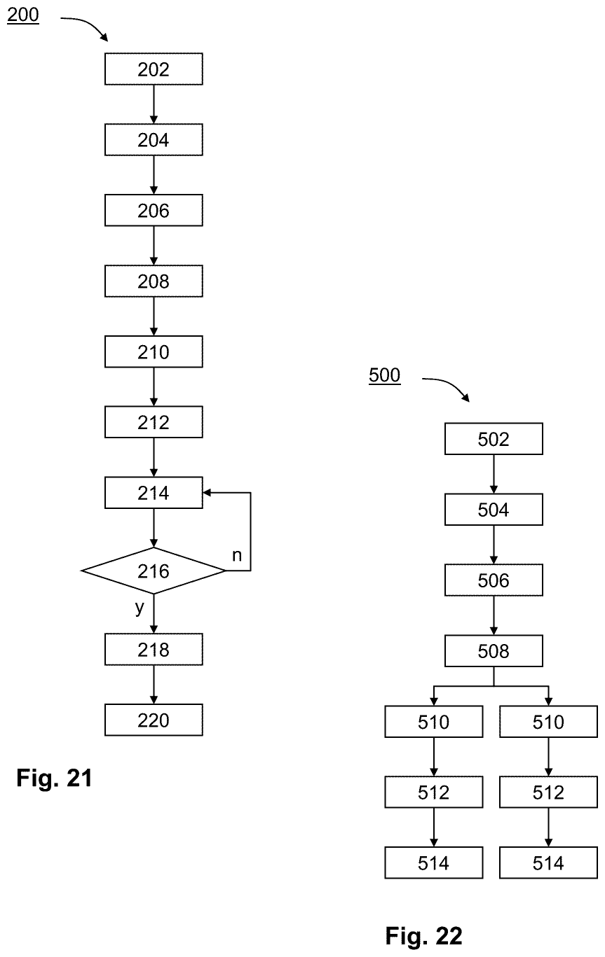

FIG. 21 shows an exemplary flow diagram of a method 200 of receiving binary data sequences represented by SCMA signals transmitted, over an OTFS communication channel subject to doubly selective fading, from two or more RRHs 400 of a CoMP radio communication system to one or more mobile UEs 300, in accordance with the second aspect of the invention. In step 202 a superposition of the signals from the at least two RRHs 400 are received at an antenna 402 of the UE 300 in the time domain. In step 204 cyclic prefixes are removed from the received time-domain signal. In step 206 an OTFS demodulation is performed on the received continuous time-domain signal, yielding corresponding two-dimensional arrangements of information symbols in the delay-Doppler domain, which are subjected, in step 208, to a signal detection, using information on the properties of the respective channels between the UE 300 and the at least two first RRHs 400. The signal detection is an iterative process for which, in step 210, the detected symbols from the at least two RRHs 400 are mapped on a factor graph having factor nodes and variable nodes, after which the iterative loop is initialized in step 212. The iteration comprises, in step 214, an iterative expectation propagation with Gaussian approximation process. At the end of each iteration, in step 216, a check is performed if a termination criterion is met. If not, “no”-branch of step 216, the iteration is repeated. Otherwise, “yes”-branch of step 216, the detected signal is output, in step 218, to a de-mapping step 220, for retrieving the transmitted signal.

FIG. 22 shows a method 500 of transmitting, from a common BBU and coincidingly within corresponding transmission slots via at least two RRHs 400 connected to the common BBU in a CoMP radio system, binary data sequences destined to two or more UEs 300 over an OTFS communication channel subject to doubly selective fading, in accordance with the third aspect of the present invention. In step 502 binary sequences for the two or more UEs 300 are received at the BBU. In step 504, each binary data sequence to be transmitted to a corresponding UE 300 is mapped into a K-dimensional SCMA codeword, and the SCMA codewords are combined into a common, or shared transmission frame in step 506. In step 508 the common, or shared, transmission frame is transmitted from the BBU to the at least two RRHs 400. Each RRH subjects the common, or shared, transmission frame to an OTFS modulation in step 510, and adds a cyclic prefix to the generated time-domain signal in step 512. In step 514 each RRH 400 transmits the resulting continuous time-domain signal over the communication channel to the two or more UEs 300.

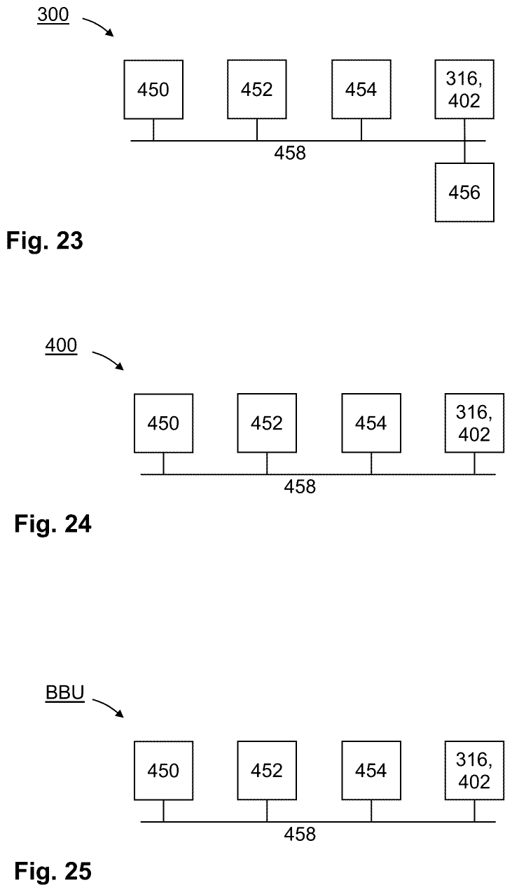

FIG. 23 shows an exemplary block diagram of a UE 300 in accordance with a further aspect of the invention. One or more antennas 316, 402 and associated transmitting and/or receiving circuitry 302-314, 404-422, one or more microprocessors 450, volatile 452 and non-volatile memory 454, are communicatively connected via one or more signal or data lines or buses 458. The non-volatile memory 454 stores computer program instructions which, when executed by the one or more microprocessors 450, configure the UE 300 to execute the method in accordance with the second aspect of the invention.

FIG. 24 shows an exemplary block diagram of an RRH 400 in accordance with yet a further aspect of the invention. One or more antennas 316, 402 and associated transmitting and/or receiving circuitry 302-314, 404-422, one or more microprocessors 450, volatile 452 and non-volatile memory 454, and one or more interfaces 456 enabling communication with a BBU and/or a further RRH are communicatively connected via one or more signal or data lines or buses 458. The non-volatile memory 454 stores computer program instructions which, when executed by the one or more microprocessors 450, configure the RRH 400 to execute the RRH-side steps of the method in accordance with the first and/or the third aspect of the invention.

FIG. 25 shows an exemplary block diagram of a BBU in accordance with yet a further aspect of the invention. One or more microprocessors 450, volatile 452 and non-volatile memory 454, and one or more interfaces 456 enabling communication with two or more RRHs 400 are communicatively connected via one or more signal or data lines or buses 458. The non-volatile memory 454 stores computer program instructions which, when executed by the one or more microprocessors 450, configure the BBU to execute the BBU-side steps of the method in accordance with the first and/or the third aspect of the invention.

### DEFINITIONS AND LIST OF REFERENCE NUMERALS (PART OF THE DESCRIPTION)

ABER average bit error rate
AWGN additive white Gaussian noise
Δf subcarrier spacing
DFT discrete Fourier transform
iSFFT inverse finite symplectic Fourier transform
M number of delay bins
MSE mean square error
MP message passing
N number of Doppler bins
OFDM orthogonal frequency division multiplexing
OTFS orthogonal time frequency space
SFFT finite symplectic Fourier transform
SNR signal-to-noise-ratio
100 method
110 receive signal
120 remove CP
130 OTFS demodulation
140 signal detection
142 receive information symbols and channel properties in common BBU
144 mapping
150 initialize & execute iteration loop
152 iterative expectation propagation with Gaussian approximation
154 exchange intermediate results
156 termination criterion met?
158 output detected signal
160 SCMA demapping
200 method
202 receive superimposed signals
204 remove CP
206 OTFS demodulation
208 signal detection
210 mapping
212 initialize & execute iteration loop
214 iterative expectation propagation with Gaussian approximation
216 termination criterion met?
218 output detected signal
220 SCMA demapping
300 transmitter/UE
302 SCMA mapper
304 SCMA codeword allocator
306 first transmitter-side transformation unit
308 second transmitter-side transformation unit
310 OTFS modulator
312 CP adder
314 transmit filter
316 antenna
400 receiver/RRH
402 antenna
404 receive filter
406 CP removal unit
408 first receiver-side transformation unit
410 second receiver-side transformation unit
412 OTFS demodulator
414 channel estimation and equalisation block
420 detector/decoder
422 SCMA demapper
450 microprocessor
452 volatile memory
454 non-volatile memory
456 interface
458 signal/data line/bus
500 method
502 receiving
504 mapping
506 combining
508 transmitting
510 OTFS modulation
512 adding CP
514 transmitting

1.-11. (canceled)

12. A method of receiving binary data sequences transmitted, over an orthogonal time-frequency space modulation (OTFS) communication channel subject to doubly selective fading, from one or more mobile user equipments (UE) to at least two remote radio heads (RRH) of a co-ordinated multipoint radio communication system, the at least two RRHs being communicatively connected to a common base band unit (BBU) and being grouped to simultaneously serve a defined area, the at least two grouped RRHs being located remote from each other such that, at any time, each of the RRHs serves any one of the one or more mobile UEs from different spatial directions with regard to said respective UE's location within the defined area, such that a Doppler shift or spread of a signal transmitted from said respective UE that is received by at least one of the at least two grouped RRHs has an opposite sign than the corresponding signal received by one or more other of the at least two grouped RRHs, the method comprising:
receiving, at each of the at least two RRHs, continuous time domain signals representing the signals transmitted from the one or more mobile UEs;
removing, in each of the at least two RRHs, cyclic prefixes from the received time-domain signals;
performing, in each of the least two RRHs, an OTFS demodulation on the received continuous time-domain signals, yielding corresponding two-dimensional arrangements of information symbols in the delay-Doppler domain;
subjecting, simultaneously and independently in each of the RRHs, the respective two-dimensional arrangements of information symbols in the delay-Doppler domain, and information on the properties of the channel between the UE and the respective RRH, to an iterative symbol detection process;
exchanging, at the end of the iterative symbol detection processes intermediate results with the at least one other RRH of the grouped RRHs;
repeating the simultaneous and independent iterative symbol detection processes, using the exchanged intermediate results as respective initialisation values, while a termination criterion is not met; and
outputting, after the termination criterion is met, the detected symbols to a de-mapping stage, for recovering the transmitted binary sequences of the respective mobile UE whose signals had been received.

13. The method of claim 12 wherein the respective iterative symbol detection process performs an iterative Gaussian approximation expectation propagation process on the information symbols.

14. The method of claim 12, wherein outputting the detected symbols to the de-mapping stage comprises transmitting the detected symbols to the common BBU for de-mapping.

15. The method of claim 12, wherein the transmitted binary data sequences are modulated using sparse code multiple access (SCMA) modulation.

16. A remote radio head (RRH) of a co-ordinated multipoint radio communication system, comprising one or more antennas and associated receiving circuitry, one or more microprocessors, volatile and non-volatile memory, which are communicatively connected via one or more signal or data lines or buses, wherein the non-volatile memory stores computer program instructions which, when executed by the microprocessor, configures the RRH to execute the method of claim 12.

17. A remote radio head (RRH) of a co-ordinated multipoint radio communication system, comprising one or more antennas and associated receiving circuitry, one or more microprocessors, volatile and non-volatile memory, which are communicatively connected via one or more signal or data lines or buses, wherein the non-volatile memory stores computer program instructions which, when executed by the microprocessor, configures the RRH to execute the method of claim 13.

18. A remote radio head (RRH) of a co-ordinated multipoint radio communication system, comprising one or more antennas and associated receiving circuitry, one or more microprocessors, volatile and non-volatile memory, which are communicatively connected via one or more signal or data lines or buses, wherein the non-volatile memory stores computer program instructions which, when executed by the microprocessor, configures the RRH to execute the method of claim 14.

19. A base band unit (BBU) of a co-ordinated multipoint radio communication system, comprising one or more antennas and associated transmitting and/or receiving circuitry, one or more microprocessors, volatile and non-volatile memory, which are communicatively connected via one or more signal or data lines or buses, wherein the non-volatile memory stores computer program instructions which, when executed by the microprocessor, configure the BBU to receive, from at least one of at least two RRHs that are communicatively connected to BBU, binary data obtained from detected and de-mapped signals received from one or more mobile UEs.

20. A base band unit (BBU) of a co-ordinated multipoint radio communication system, comprising one or more antennas and associated transmitting and/or receiving circuitry, one or more microprocessors, volatile and non-volatile memory, which are communicatively connected via one or more signal or data lines or buses, wherein the non-volatile memory stores computer program instructions which, when executed by the microprocessor, configure the BBU to receive, from at least one of at least two RRHs that are communicatively connected to BBU, symbols detected in signals received from one or more mobile UEs, and to de-map the received symbols, for obtaining binary data carried therein.

21. A co-ordinated multipoint radio communication system comprising two or more remote radio heads in accordance with claim 16 communicatively connected to a common base band unit comprising one or more antennas and associated transmitting and/or receiving circuitry, one or more microprocessors, volatile and non-volatile memory, which are communicatively connected via one or more signal or data lines or buses, wherein the non-volatile memory stores computer program instructions which, when executed by the microprocessor, configure the BBU to receive, from at least one of at least two RRHs in accordance with claim 16 that are communicatively connected to the BBU, binary data obtained from detected and de-mapped signals received from one or more mobile UEs.

22. A co-ordinated multipoint radio communication system comprising two or more remote radio heads in accordance with claim 18 communicatively connected to a common base band unit comprising one or more antennas and associated transmitting and/or receiving circuitry, one or more microprocessors, volatile and non-volatile memory, which are communicatively connected via one or more signal or data lines or buses, wherein the non-volatile memory stores computer program instructions which, when executed by the microprocessor, configure the BBU to receive, from at least one of at least two RRHs in accordance with claim 18 that are communicatively connected to the BBU, symbols detected in signals received from one or more mobile UEs, and to de-map the received symbols, for obtaining binary data carried therein.

23. A computer program product comprising computer program instructions which, when executed by a microprocessor, cause a computer and/or control hardware blocks, modules or components of a remote radio head (RRH) of a co-ordinated multipoint radio communication system to execute the method of claim 12.

24. A computer program product comprising computer program instructions which, when executed by a microprocessor, cause a computer and/or control hardware blocks, modules or components of a remote radio head (RRH) of a co-ordinated multipoint radio communication system to execute the method of claim 13.

25. A computer program product comprising computer program instructions which, when executed by a microprocessor, cause a computer and/or control hardware blocks, modules or components of a remote radio head (RRH) of a co-ordinated multipoint radio communication system to execute the method of claim 14.

26. A computer program product comprising computer program instructions which, when executed by a microprocessor, cause a computer and/or control hardware blocks, modules or components of a base band unit (BBU) of a co-ordinated multipoint radio communication system comprising two or more remote radio heads (RRH) communicatively connected to the BBU, to receive, from at least one of the two or more RRHs, symbols detected in signals that are wirelessly received at the at least one RRH from one or more mobile user equipments (UE), and to de-map the received symbols for obtaining binary data carried therein.

27. A computer program product comprising computer program instructions which, when executed by a microprocessor, cause a computer and/or control hardware blocks, modules or components of a base band unit (BBU) of a co-ordinated multipoint radio communication system comprising two or more remote radio heads (RRH) communicatively connected to the BBU, to receive, from at least one of the two or more RRHs, binary data obtained from detected and de-mapped signals that are wirelessly received at the at least one RRH from one or more mobile UEs.

28. A non-transitory computer-readable medium or data carrier retrievably transmitting or storing the computer program product of claim 23.

29. A non-transitory computer-readable medium or data carrier retrievably transmitting or storing the computer program product of claim 24.

30. A non-transitory computer-readable medium or data carrier retrievably transmitting or storing the computer program product of claim 25.

31. A non-transitory computer-readable medium or data carrier retrievably transmitting or storing the computer program product of claim 26.

32. A non-transitory computer-readable medium or data carrier retrievably transmitting or storing the computer program product of claim 27.
